(19) United States
(12) Patent Application Publication
(10) Pub. No.: US 2026/0140262 A1
(43) Pub. Date: May 21, 2026

(54) TIME-OF-FLIGHT CAMERA SYSTEM

(71) Applicant: LUCID Vision Labs, Inc., Burnaby (CA)

(72) Inventors: Jeffrey D. BULL, New Westminster (CA); Colin R. DOUTRE, Vancouver (CA); Roderick BARMAN, Vancouver (CA); Dairoku SEKIGUCHI, Kashiwa-shi (JP)

(73) Assignee: LUCID Vision Labs, Inc., Burnaby, BC (CA)

(21) Appl. No.: 19/388,781

(22) Filed: Nov. 13, 2025

Related U.S. Application Data
(60) Provisional application No. 63/721,382, filed on Nov. 15, 2024.

(51) Int. Cl. G01S 17/89; G01S 17/08

(52) U.S. Cl. CPC G01S 17/89; G01S 17/08

(57) ABSTRACT

A time-of-flight camera system to measure distance to a target is described. A light emitter is configured to generate emitted light directed towards the target to produce reflected light from the target. An optical sensor defines a plurality of sensing locations, at least partially distributed parallel to a blurring axis, to sense the reflected light. A blurring element is optically positioned between the optical sensor and the target so as to blur light received by the optical sensor. The blurring element is configured to cause a predetermined spreading of light parallel to the blurring axis at the plurality of sensing locations to reduce light intensity thereat. The time-of-flight camera system is operable to determine the distance to the target based on sensed light, the emitted light, and the predetermined spreading of the light.

### TECHNICAL FIELD

The disclosure relates generally to distance sensing devices, and more particularly to time-of-flight cameras.

### BACKGROUND

Time-of-flight (ToF) cameras measure depth of an object based on the time taken for an electromagnetic signal, e.g. light signal, to travel to and from an object.

Direct time-of-flight cameras determine depth by calculating a time delay between emission of a signal and receipt of a return (reflected) signal. For example, such signals may be non-periodic so as to allow determination of a unique distance. While direct time-of-flight cameras allow for large unambiguous ranges, their accuracy and precision are relatively limited.

Indirect time-of-flight (iToF) cameras determine depth and three-dimensional shape by projecting a modulated continuous-wave carrier electromagnetic signal, e.g. light signal, onto a scene and measuring the phase delay of a return (reflected) signal to calculate depth. For each pixel in the image, the image sensor calculates the phase delay of the reflected light based on a set of correlation measurements of the reflected light at different phase angles relative to the emitted light. One common method is to measure four equally spaced correlation signals at 0, 90, 180 and 270 degrees phase angles relative to the emitted light. Denoting these four correlation signals c₀, c₁, c₂ and c₃. The depth of the reflected light can be calculated as:

$$d = \frac{s}{4 π {f}_{mod}} {tan}^{- 1} ( \frac{{c}_{3} - {c}_{1}}{{c}_{0} - {c}_{2}} )$$

where S is the speed of light, f_{mod} is the modulation frequency, c₀ is the correlation signal for the pixel at 0 deg phase angle, c₁ is the correlation signal for the pixel at 90 deg phase angle, c₂ is the correlation signal for the pixel at 180 deg phase angle, and c₃ is the correlation signal for the pixel at 270 deg phase angle. It is often useful to measure the amplitude of the reflected light at each pixel in addition to its associated depth. For such 4-phase iToF cameras (systems), amplitude can be calculated as:

$$A = \sqrt{{( {c}_{0} - {c}_{2} )}^{2} + {( {c}_{3} - {c}_{1} )}^{2}}$$

A different number of correlation measurements can be used to calculate depth with suitable changes to the equation used. Time-of-flight optical sensors commonly measure depth at a single point or over a 2D grid forming a 2D depth image. For iToF phase measurements, when the phase delay exceeds 360 degrees (2π radians), it ‘wraps’ back to 0 degrees. In other words, a phase delay of x degrees and x+2nπ degrees cannot be distinguished, as for any integer value of n the pulses will be overlapping. While indirect time-of-flight cameras allow for relatively high accuracy and precision, their maximum unambiguous ranges are relatively limited due to phase wrapping.

For time-of-flight cameras, when using light generators to emit incident signals and using optical sensors defining pixels to detect the corresponding return signals, it is important to manage saturation of the individual pixels since otherwise the return signals may not be accurately detected or may be missed. Optical sensors can include CMOS, CCD, SPAD, or other types of sensors. For example, it may be important to reset the pixels periodically to prevent saturation.

Line-scan cameras generally employ a single sensor element to generate two-dimensional visual images. Such cameras typically incorporate swiftly rotating optical elements to facilitate scanning in one direction, while the motion of the recording material, such as photographic film, facilitates scanning in the perpendicular direction. During the 1960s to the 1980s, line scanning found extensive application in both visible light and, predominantly, infrared imaging, notably in aerial reconnaissance. Examples include the Corona spy satellites, employing a telescope that moved laterally as film passed through, yielding striped imagery. Similarly, the camera on Pioneer 10 utilized a fixed-position polarimeter sensor, with spacecraft rotation providing one scanning direction and its trajectory through space providing the other. The advent of sensitive electronic array sensors in the 1980s and 1990s has led to a reduced reliance on line-scan cameras for satellites. Nevertheless, line-scan cameras have found new applications, such as for monitoring materials being transferred on conveyor belts in agriculture, logistics, mail sorting, and manufacturing; for inspecting printed surfaces; and for use in race timing systems for “photo finish” events. Modern line-scan cameras commonly employ a sensor stripe to capture images in one dimension while leveraging camera or object movement for the other dimension.

### SUMMARY

It is found that improved performance of alight-based time-of-flight camera may be achieved by placing an optical element in the path of a light sensor of the camera so that returning light to the light sensor is blurred in a predetermined manner in a specific blurring direction to thereby reduce light intensity at the light sensor. A depth may then be determined by combining sensed light by the light sensor in the blurring direction.

Efficient line-scanning depth sensing may be achieved by causing a light emitter of the time-of-flight camera to project, for the purposes of producing a reflection for depth sensing, a line of light that is lateral or non-parallel to the blurring direction, and then moving this line of light across a target so as to be sequentially sensed by a two-dimensional sensor, e.g. comprising a two-dimensional array of pixel sensors.

By offsetting the light emitter and the light sensor from each other, the parallax of the line of light, as sensed by the light sensor, can be used to infer a distance, which distance can then be used for phase unwrapping in indirect time-of-flight systems. Advantageously, larger unambiguous distances may be achieved with improved precision and accuracy.

In an aspect, there is described a time-of-flight camera system to measure distance to a target in a scene. The time-of-flight camera system also includes a light emitter configured to generate emitted light directed towards the target to produce reflected light from the target, the emitted light being elongated perpendicular to a blurring axis; an optical sensor defining a plurality of sensing locations to sense the reflected light, the plurality of sensing locations being distributed parallel to the blurring axis; an image-forming objective optically positioned between the optical sensor and the target; and a blurring element optically positioned between the optical sensor and the target to blur light that is to be received by the optical sensor via the objective, the blurring element and the image-forming objective together configured to cause a predetermined spreading of light parallel to the blurring axis at the plurality of sensing locations to reduce light intensity at one or more of the plurality of sensing locations, where the time-of-flight camera system is operable to determine the distance to the target based on sensed light at each of the plurality of sensing locations, the emitted light, and the predetermined spreading of the light by the blurring element. Embodiments of this aspect include corresponding computer systems, apparatus, and computer programs recorded on one or more computer storage devices, each configured to perform the actions of the methods.

Implementations may include one or more of the following optional features. The time-of-flight camera system further comprising one or more processors; and non-transitory, computer-readable memory coupled to the one or more processors and storing processor-executable instructions that, when executed, configure the one or more processors to: receive data, via the optical sensor, indicative of the sensed light at each of the plurality of sensing locations, and use the data to determine distance data indicative of the distance to the target based on the sensed light at each of the plurality of sensing locations, the emitted light, and the predetermined spreading of the light by the blurring element. The time-of-flight camera system where the predetermined spreading of light parallel to the blurring axis is unidirectional spreading of light, the emitted light is a line of emitted light non-parallel to the blurring axis, the reflected light is at least partially sensed by the optical sensor via the blurring element to define an imaged line associated with reflection of the line of emitted light to facilitate line scanning of the target, and the one or more processors is configured to use the data to determine a one-dimensional distance array associated with the imaged line and indicative of corresponding distances of one or more objects in the scene. The light emitter and the optical sensor are laterally offset from each other relative to the target, the emitted light is a modulated optical wave, and the one or more processors is configured to use the data to determine a plurality of candidate distances to the target based on phase delay, relative to the emitted light, of the reflected light, estimate a parallax of the imaged line based on the data and an offset between the light emitter and the optical sensor, and determine the distance to the target using the plurality of candidate distances and the parallax of the imaged line. The predetermined spreading of light parallel to the blurring axis is unidirectional spreading of light, the light emitter is configured to emit a sequence of lines of light non-parallel to the blurring axis to generate reflected light sensed by the optical sensor via the blurring element to define a corresponding sequence of imaged lines to facilitate line scanning of the target, and the one or more processors are configured to use the data to determine a depth map based on a sequence of one-dimensional distance arrays determined based on the corresponding sequence of imaged lines. The blurring element is a cylindrical lens configured to cause spreading of light parallel to the blurring axis while mitigating spreading of light perpendicular to the blurring axis. The optical sensor may include a two-dimensional array of pixel sensors. The blurring element is configured such that the predetermined spreading of light parallel to the blurring axis is unidirectional spreading of light, and the objective is optically positioned between the blurring element and the optical sensor. The time-of-flight camera system may include: a screen defining a slit and optically positioned between the objective and the optical sensor to block light reaching the plurality of sensing locations from the objective, the objective being configured to allow passage of the reflected light through the slit towards the optical sensor. The objective forms an intermediate image plane between the objective and the optical sensor, the time-of-flight camera system may include: a relay lens optically positioned between the intermediate image plane and the optical sensor. The light emitter defines an array of laser beam generators that are mutually incoherent and positioned relative to each other to generate a line of light. The blurring element is configured to cause a non-uniform spreading of the light parallel to the blurring axis to mitigate sensor saturation of the optical sensor by non-uniformly reducing light intensity parallel to the blurring axis. The one or more processors is configured to use the data to determine the distance data indicative of the distance to the target based on a plurality of accumulated correlations, each of the plurality of accumulated correlations being associated with a corresponding phase shift and being determined based on a corresponding plurality of correlations associated with the corresponding phase shift between the emitted light and the sensed light. Said each of the plurality of accumulated correlations is a weighted average of the corresponding plurality of correlations, the weighted average being based on weights at least partially determined by the predetermined spreading of light by the blurring element. Said each of the plurality of accumulated correlations is a weighted average of the corresponding plurality of correlations, the weighted average being based on data indicative of a plurality of electron counts, each of the plurality of electron counts being associated with a corresponding one of the plurality of correlations. The blurring element is selected from a group including or consisting of a lens, a diffractive optical element, and a diffuser. The light emitter, the optical sensor, the objective, the blurring element, the one or more processors, and the non-transitory, computer-readable memory form an integrated camera assembly. Implementations of the described techniques may include hardware, a method or process, or computer software on a computer-accessible medium.

In an aspect, there is described a method of determining distance to a target. The method also includes generating emitted light directed towards the target to produce reflected light from the target; causing a predetermined spreading of the reflected light parallel to a blurring axis to reduce light intensity and generate blurred light suitable for imaging; sensing the blurred light using an optical sensor to generate data indicative of the blurred light; and determining time-of-flight of light to determine the distance of the target, the time-of-flight being determined based on the data, the emitted light, and the predetermined spreading of the reflected light. Embodiments of this aspect include corresponding computer systems, apparatus, and computer programs recorded on one or more computer storage devices, each configured to perform the actions of the methods.

Implementations may include one or more of the following features. The method where generating the emitted light directed towards the target to produce reflected light from the target may include generating a line of emitted light non-parallel to the blurring axis directed towards the target to produce the reflected light from the target, the reflected light being sensed by the optical sensor to define an imaged line associated with reflection of the line of emitted light to facilitate line scanning of the target, and determining the time-of-flight of light based on the data, the emitted light, and the predetermined spreading of the reflected light to determine the distance of the target may include determining a one-dimensional distance array associated with the imaged line. Generating the emitted light directed towards the target to produce the reflected light from the target may include generating the emitted light from a light emitter that is laterally offset from the optical sensor relative to the target, such that the emitted light is a modulated optical wave forming a line of emitted light, and where determining the time-of-flight of light based on the data, the emitted light, and the predetermined spreading of the reflected light to determine the distance of the target may include using the data to determine a plurality of candidate distances to the target based on phase delay, relative to the emitted light, of the blurred light, using the data to estimate a parallax of the imaged line based on an offset between the light emitter and the optical sensor, and determining the distance to the target using the plurality of candidate distances and the parallax of the imaged line. Determining the time-of-flight of light based on the data, the emitted light, and the predetermined spreading of the reflected light to determine the distance of the target may include determining the distance of the target based on a plurality of accumulated correlations, each of the plurality of accumulated correlations being associated with a corresponding phase shift and being determined based on a weighted averaging of a corresponding plurality of correlations associated with the corresponding phase shift between the emitted light and the blurred light. Generating the emitted light directed towards the target to produce the reflected light from the target may include generating a plurality of mutually incoherent laser beams that are positioned relative to each other to generate a line of emitted light. Causing the predetermined spreading of the reflected light parallel to the blurring axis to reduce light intensity and generate blurred light may include causing non-uniform spreading of light parallel to the blurring axis to non-uniformly reduce light intensity parallel to the blurring axis. Determining the time-of-flight of light based on the data, the emitted light, and the predetermined spreading of the reflected light to determine the distance of the target may include determining the distance of the target based on a plurality of accumulated correlations, each of the plurality of accumulated correlations being associated with a corresponding phase shift and being determined based on a corresponding plurality of correlations associated with the corresponding phase shift between the emitted light and the blurred light. Determining the distance of the target based on a plurality of accumulated correlations, each of the plurality of accumulated correlations being associated with a corresponding phase shift and being determined based on a corresponding plurality of correlations associated with the corresponding phase shift between the emitted light and the blurred light, may include determining the distance based on each of the plurality of accumulated correlations being a weighted average of the corresponding plurality of correlations, the weighted average being based on weights at least partially determined by the predetermined spreading of the reflected light. Causing the predetermined spreading of the reflected light parallel to the blurring axis to reduce light intensity and generate blurred light may include using a blurring element to spread the reflected light, the blurring element being selected from a group that may include a lens, a diffractive optical element, and a diffuser. Implementations of the described techniques may include hardware, a method or process, or computer software on a computer-accessible medium.

As referred to herein, a camera system may comprise an imaging device connected to an external computing device, e.g. an imaging device network-connected to a remote server. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Embodiments can include combinations of the above features.

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by a data processing apparatus, cause the apparatus to perform the actions.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a perspective view of a time-of-flight camera system, in accordance with an embodiment;

FIG. 1B is a perspective view of a time-of-flight camera system, in accordance with another embodiment;

FIG. 2 is a schematic representation of a time-of-flight camera system, in accordance with an embodiment;

FIG. 3 is a schematic representation of a time-of-flight camera system illustrating example light rays as they travel therethrough, in accordance with an embodiment;

FIG. 4 shows a photograph of a light line as projected by a laser line generator onto a target by a time-of-flight camera system, in accordance with an embodiment;

FIG. 5 shows a photograph of a blurred light line as generated by an optical assembly, in accordance with an embodiment;

FIG. 6A is a first optical blurring filter response indicative of a first predetermined spreading of light by a lens, in accordance with an embodiment;

FIG. 6B are second and third optical blurring filter responses indicative of respective second and third predetermined spreading of light by a lens, in accordance with another embodiment;

FIG. 7 is a schematic representation of a time-of-flight camera system illustrating exemplary light rays as they travel through the time-of-flight camera system, in accordance with another embodiment;

FIG. 8 is a schematic representation of a time-of-flight camera system illustrating exemplary light rays as they travel through the time-of-flight camera system, in accordance with yet another embodiment;

FIG. 9 is a flow chart of a computer-implemented method for determining distance to a target, in accordance with an embodiment;

FIG. 10 is a flow chart of a method of determining distance to a target, in accordance with an embodiment; and

FIG. 11 illustrates a block diagram of a computing device, in accordance with an embodiment of the present application.

### DETAILED DESCRIPTION

A time-of-flight camera system to measure distance to a target is described. A light emitter is configured to generate emitted light elongated at least partially perpendicular to a blurring axis and directed towards the target to produce reflected light from the target. An optical sensor defines a plurality of sensing locations, at least partially distributed along the blurring direction, to sense the reflected light. A blurring element, e.g. a lens, is positioned between the optical sensor and the target so as to blur light that is to be received by the optical sensor. The blurring element is configured to cause a predetermined spreading of light in the blurring direction at the plurality of sensing locations to reduce light intensity thereat. One or more processor(s) may be configured to receive data, via the optical sensor, indicative of sensed light at each of the plurality of sensing locations, and use the data to determine distance data indicative of the distance to the target based on sensed light, the emitted light, and the predetermined spreading of the light.

Aspects of various embodiments are described in relation to the figures.

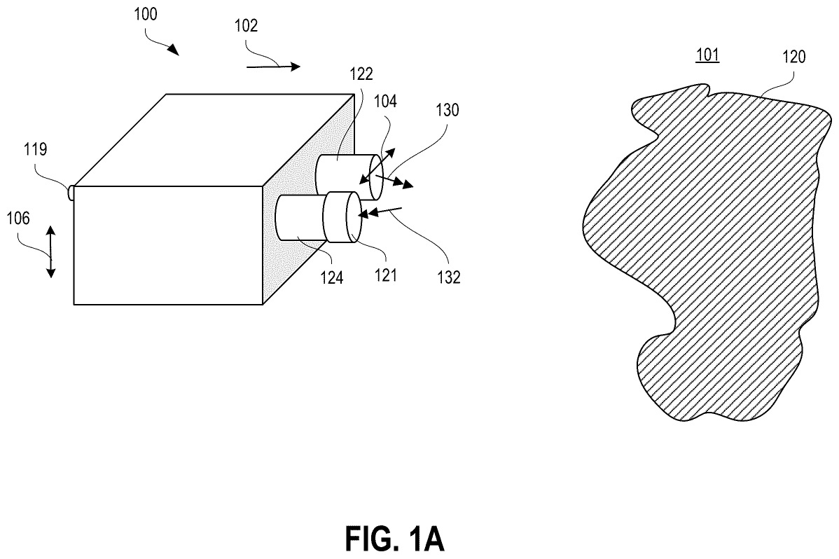

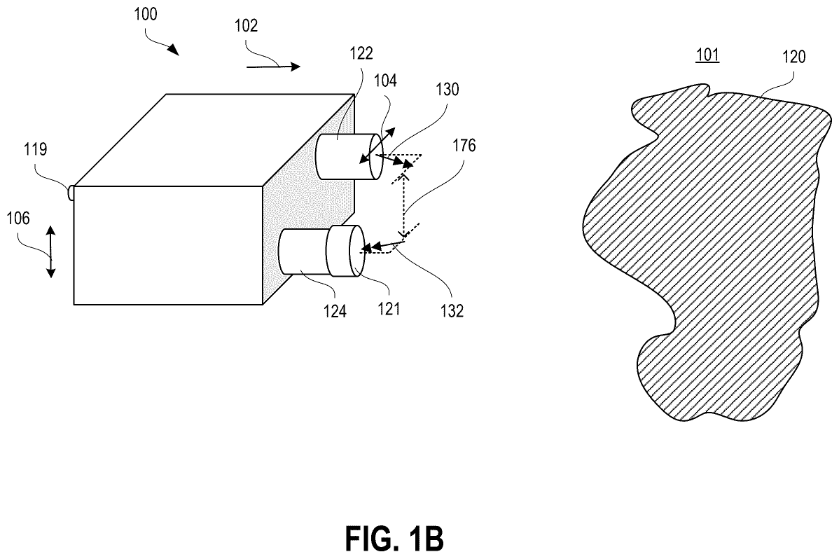

FIG. 1A is a perspective view of a time-of-flight (ToF) camera system 100 (or camera), in accordance with an embodiment.

FIG. 1B is a perspective view of a time-of-flight (ToF) camera system 100 (or camera), in accordance with another embodiment. The ToF camera system 100 may be an indirect ToF camera.

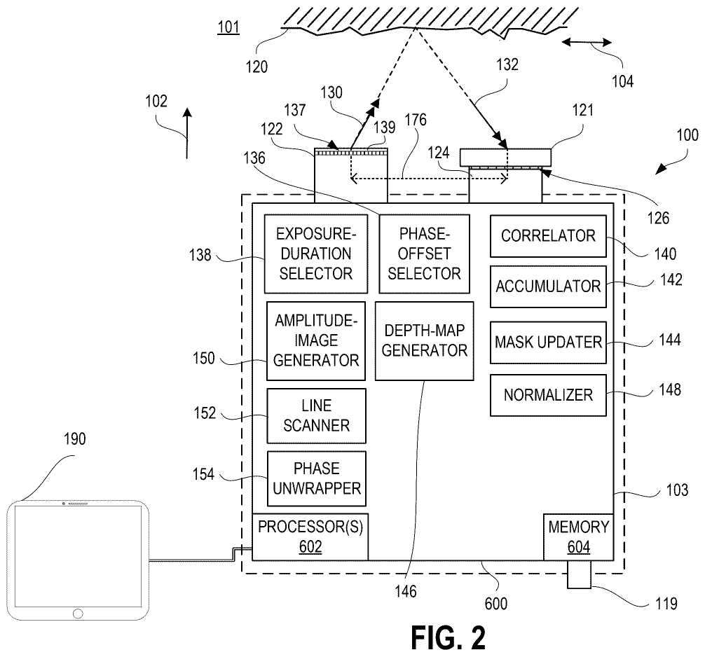

FIG. 2 is a schematic representation of a ToF camera system 100, in accordance with an embodiment.

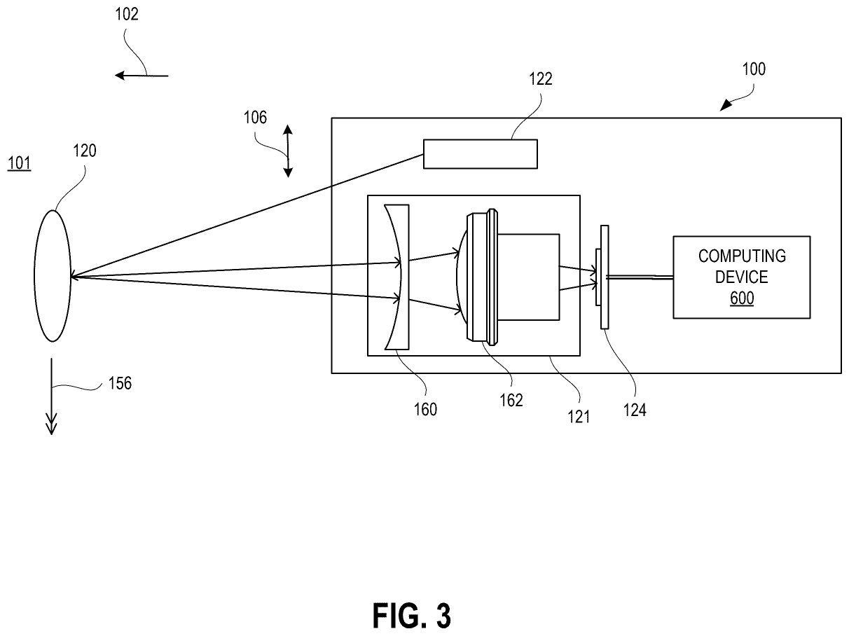

FIG. 3 is a schematic representation of a ToF camera system 100 illustrating example light rays as they travel through the ToF camera system 100, in accordance with an embodiment.

Referring to FIGS. 1A-1B, the ToF camera system 100 is oriented towards a scene 101, e.g. as defined by a field of view of the ToF camera system 100, that contains a target 120. The target 120 includes any number of objects in the scene 101.

The ToF camera system 100 is operable to generate a depth map indicating distance(s) between the ToF camera system 100 (or an optical sensor and a light emitter thereof) and the target 120. In some embodiments, the ToF camera system 100 is also operable to determine an amplitude image as a grey-scale representation of the scene within the field of view of the ToF camera system 100. Such a representation is typically suitable for human viewing when displayed on a digital display or other type of visual output device, such as interface 190, which in various embodiments forms part of the ToF camera system 100 and/or is external thereto.

Referring to FIG. 2, the ToF camera system 100 may include circuitry for processing that forms a computing device 600. As shown in FIG. 2, the computing device 600 includes one or more processors 602, and non-transitory, machine-readable (computer-readable) memory 604 coupled to the one or more processors 602. The memory 604 stores processor-executable (and/or machine interpretable) instructions that, when executed, configure the one or more processors control operations of the ToF camera system 100, e.g. by executing one or more actions, and/or steps of one or more methods. In various embodiments, the computing device 600 may be an external computing device 600 that is network-connected to components of the ToF camera system 100.

The ToF camera system 100 may include user input devices. For example, the ToF camera system 100 may include a graphical user interface implemented via a touchscreen, e.g. via the interface 190. In some embodiments, such as the embodiment shown in FIGS. 1A-1B, and FIG. 2, the ToF camera system 100 may include a button 119 operable by a user to cause the circuitry to effect one or more steps of a method.

The ToF camera system 100 includes a light emitter 122 configured to generate emitted light 130 directed towards the target 120 to produce reflected light 132 from the target 120. The light emitter 122 may generate emitted light 130 directed towards one or more locations on the target 120 to produce reflected light 132 therefrom to facilitate the ToF camera system 100 in determining the depth associated with the one or more locations on the target 120.

The light emitter 122 generally directs the emitted light 130 at least partially along a longitudinal direction 102. The direction of emitted light 130 may be predetermined. Additionally, the direction of emitted light may be varied. For example, as well be discussed later, a line of light extending generally parallel to a line axis 104 may be generated by the light emitter 122. A blurring axis 106 may be generally non-parallel to the line axis 104 and the longitudinal direction 102. The light emitter 122 is configured to generate emitted light 130 elongated at least partially perpendicular to the blurring axis 106 and directed towards the target 120 to produce reflected light from the target 120. Referring to FIGS. 1A-1B, the blurring axis 106 is lateral (perpendicular) to the line axis 104. As will be apparent later, it may be particularly advantageous for the blurring axis 106 to be lateral to the line axis 104.

In the embodiment of FIG. 1A, the light emitter 122 and the optical sensor 124 are spaced apart along the line axis 104 while being substantially not spaced apart (coincident) along the blurring axis 106. When the light emitter 122 emits a line of light towards the target 120, the parallax due to the offset between the light emitter 122 and optical sensor 124 may not be discernible at the optical sensor 124.

In the embodiment of FIG. 1B, the light emitter 122 and the optical sensor 124 are spaced apart along the line axis 104 and the blurring axis 106. In some embodiments, the light emitter 122 and the optical sensor 124 are spaced apart along the blurring axis 106 while being substantially not spaced apart (coincident) along the line axis 104. In these embodiments, when the light emitter 122 emits a line of light towards the target 120, since the light emitter 122 and the optical sensor 124 are offset relative to each other perpendicular to the line axis 104, the parallax due to the offset between the light emitter 122 and optical sensor 124 is discernible at the optical sensor 124.

Advantageously, the embodiment of FIG. 1A may allow use of a slit to block stray light while reducing parallax-induced discrepancies. Advantageously, the embodiment of FIG. 1B may facilitate use of discernible parallax to achieve phase unwrapping.

In some embodiments, the light emitter 122 is an edge emitting semiconductor laser. For example, an edge emitting semiconductor laser generates a laser beam, which then is conveniently collimated and then expanded in one direction into a diverging fan shape which projects as a line on the target 120. The optical sensor 124 may be prone to depth errors related to laser speckle, which may be exacerbated by use of an edge emitting semiconductor laser to generate a light line.

Referring to FIG. 2, the light emitter 122 defines an array of laser beam generators 137 that are positioned relative to each other so as to generate a line of light on the target 120. The array of laser beam generators 137 are distributed along a direction parallel to the line axis 104. The line of light generated in such a way is a low coherence laser line in some embodiments. Advantageously, in some embodiments, the laser beam generators are vertical-cavity surface-emitting lasers (VCSELs). Individual generators in the array of laser beam generators 137 are not in coherence with each other, i.e. they may be mutually incoherent. This lack of mutual coherence arises due to random variations in output wavelength between individual generators. As such, if the light of the individual generators is overlapped, speckling is advantageously reduced.

In various embodiments, the array of laser beam generators 137 are arranged in a two-dimensional or a one-dimensional array. A one-dimensional array of laser beam generators 137 is particularly advantageous for generating a narrow laser line projection on the target 120, since the spatial extent of a desired line projected on to the target 120 perpendicular to the one-dimensional array would be similar to that of a single emitter. Advantageously, a light line with small thickness and low divergence can be formed.

In various embodiments, the light emitter 122 further includes one or more optical elements 139 positioned in front of the array of laser beam generators 137 to receive light emitted therefrom. The one or more optical elements 139 collimate and/or spread received light in one dimension (parallel to the line axis 104). The one or more optical elements 139 form a fan in some embodiments. In various embodiments, the one or more optical elements 139 include a one-dimensional diffuser, a one-dimensional refractive lens, a diffractive optical element, and/or or lens array. In the case where the array of laser beam generators 137 forms a rectangular array, it is found that making the long axis of the rectangular array parallel to the line axis 104 facilitates achieving thin projected laser lines.

The ToF camera system 100 includes an optical sensor defining a plurality of sensing locations, at least partially distributed along a direction parallel to the blurring axis 106, to sense the reflected light. In the embodiments shown in FIG. 2, the plurality of sensing locations are the pixels 126.

The ToF camera system 100 in some embodiments operable to modulate an optical carrier wave with a modulating signal having a relative phase, or phase offset, selected by a phase-offset selector 136. In various embodiments, the optical carrier wave is an infrared light wave, a visible lightwave, other light wave, or any combination thereof, for example. In various embodiments, the modulating signal is another periodic signal or combination of periodic signals. The light emitter 122 emits the modulated optical wave as modulated optical energy directed toward the target 120 for a time period, or number of periodic cycles of the modulating signal, associated with an exposure duration selected by the exposure-duration selector 138. For example, the modulated optical wave in some embodiments is a modulated continuous-wave carrier signal.

The target 120, e.g. object(s), may typically be non-transparent and reflect optical energy (emitted light 130) that is then sensed by the ToF camera system 100 as reflected optical energy impinging on image-sensing locations (pixels 126) of the optical sensor 124, as shown in FIG. 2. The reflected light 132 that is received by an optical assembly 121 to serve as an image forming element while causing blurring of the reflected optical energy (blurred light) in a predetermined fashion. The reflected optical energy then impinges on the image-sensing pixels 126 of the optical sensor 124. As such, the optical assembly 121 and/or lenses thereof act as an optical blurring filter. In embodiments of line-scan ToF camera systems, a high-resolution image is formed via the optical assembly 121 in a first direction parallel to the scanning line, while a pre-determined amount of blurring, or reduction in resolution, in a second direction perpendicular to the scanning line is affected by the optical blurring filter.

The light emitter 122 and the optical sensor 124 (and/or the optical assembly 121) are, in some embodiments, laterally offset from each other relative to the target 120 and in a direction perpendicular to the line axis 104 by an offset 176 so as not to physically overlap, i.e. the line of sight from the light emitter 122 to target 120 does not overlap the line of sight from the target 120 to the optical sensor 124. The offset 176 is typically defined as the distance between the optical sensor 124 and the light emitter 122, in a direction parallel to the blurring axis 106 or in a direction perpendicular to the line axis 104 and the line of sight from the light emitter 122 to the target 120. In various embodiments, the distance, in a direction parallel to the blurring axis 106 (or perpendicular to both the line axis 104 the line of sight between the light emitter 122 and the target 120) between the centreline of the light emitter 122 and the optical sensor 124, which may be defined as the offset 176 in some cases, may be significantly larger than either a maximum spacing between any two light emitting portions of the light emitter 122 and a maximum spacing between any two pixels of the optical sensor 124. Generally, it is desirable to keep the offset 176 as small as possible to mitigate occlusions. However, it is found the existence of sufficiently prominent offset 176 may be particularly advantageous for indirect time-of-flight line-scan systems.

Due to the offset 176, light emitted by the light emitter 122 travels a first path and reflected light sensed by the optical sensor 124 travels a second path generally non-overlapping with the first path, which gives rise to parallax when viewing the reflected light at the optical sensor 124, i.e. a shape projected by the light emitter 122 will be slightly distorted and/or offset from a vantage point of the optical sensor 124. As such, if the offset 176 is at least partially lateral to the direction of a light line emitted by the light emitter 122 towards an object, the position of the line in the resulting image formed at the optical sensor 124 will change based on the distance between the ToF camera system 100 and the object due to the parallax effect. As will be discussed later, this parallax can be used to “unwrap” the measured phase angle and extend the measurement range beyond what is normally possible with a single modulation frequency in indirect time-of-flight systems and methods (phase unwrapping). It is particularly advantageous for the offset 176 to be perpendicular to the emitted line of light.

In various embodiments, the optical sensor 124 is suitable to perform an area scan, e.g. based on an aspect ratio of 4:3 or 3:2. For example, time-of-flight image sensors commonly operate with such aspect ratio. In some embodiments, for line scan applications wherein the light emitter 122 generates a light line, the optical sensor 124 is configured to use a small vertical (extending parallel to the blurring axis 106) region of interest (ROI) around the reflected line to speed up image readout and achieve a higher frame rate.

As such, in various embodiments, with a line light from the light emitter 122, only a limited number of pixels measure light in each column of pixels and there are several rows of pixels above and below the line that are not used. By selectively adding a predetermined vertical optical blurring filter to the camera's optical path, these empty pixels are used to measure light at the same depth (or distances to portions of the target 120) as the pixels directly on the line. In various embodiments, an optical blurring filter is aligned precisely to the pixel grid to avoid horizontal blur which would reduce detail in the output line by mixing signal from different columns that could potentially be at different depths (or distances).

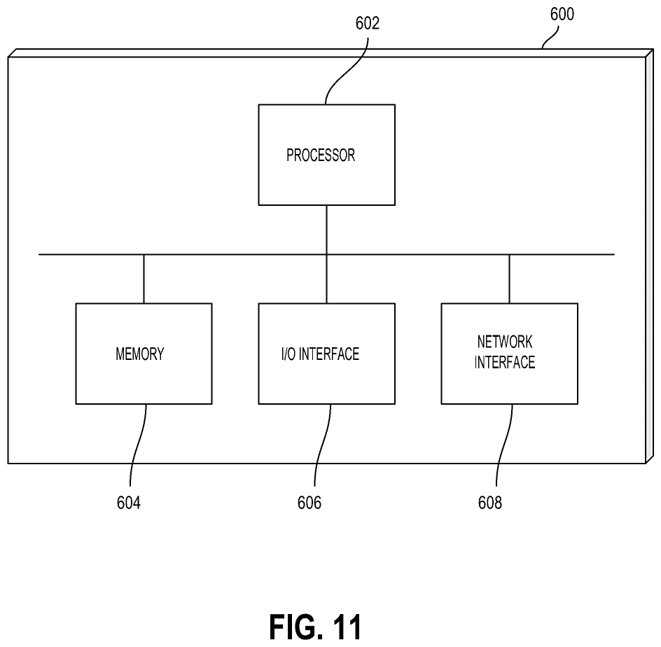

Referring to FIG. 11, In various embodiments, the one or more processors 602 are operable to receive data, via the optical sensor 124, indicative of sensed light at each of the plurality of sensing locations (pixels 126) of the optical sensor 124. In various embodiments, the one or more processors 602 are configured to use the data to operate the ToF camera system 100, e.g. to execute one or more steps of method(s) described herein. For example, when programmed to determine quantities or take actions based on sensed light, the one or more processors 602 use the data to achieve the same.

The optical assembly 121 includes a blurring element for blurring the reflected light along (a direction parallel to) the blurring axis 106 while mitigating blurring in directions perpendicular to the blurring axis 106, as described above. For example, the blurring element may include one or more lenses, one or more diffusers, one or more diffractive optical elements, and/or other elements suitable to spread (and possibly also attenuate) received light. In some embodiments, the blurring element is selected from a group consisting of a lens, a diffractive optical element, and a diffuser. The ToF camera system 100 is suitable to determine a distance between the target 120 and the ToF camera system 100 (and/or components thereof) based on the travel time of light in the ambient medium from the light emitter 122 to the target 120 and then back to the optical sensor 124. The optical sensor 124 is a time-of-flight image sensor in the described embodiments.

As shown in FIG. 3, the optical assembly 121 includes a blurring element optically positioned between the optical sensor 124 and the target 120 so as to blur light received by the optical sensor 124. Thus, the blurring element is positioned in space so as to lie on an optical path between the optical sensor 124 and the target 120. As shown in FIGS. 3, 5, 7-8, the blurring element may be a lens 160.

In some embodiments, as shown by way of example in FIGS. 3, 5, 7-8, the lens 160 and/or other blurring element(s) may be geometrically positioned between the optical sensor 124 and the target 120 so as to intercept reflected light from the target 120 to cause blurring thereof such that the optical sensor 124 receives the reflected light as blurred by the lens 160. It is conceived that, in some embodiments, the lens 160 and/or other blurring element may be positioned at a location in space other than (geometrically) between the optical sensor 124 and the target 120 if the reflected light nevertheless reaches the optical sensor 124 via the respective lens 160 and/or other blurring element, e.g. the use of one or more reflective/refractive elements may allow a greater degree of flexibility in spatial positioning of the lens 160 and/or other blurring element. It is particularly advantageous, in some cases, to geometrically position blurring element(s) between the optical sensor 124 and the target 120. For example, a device size may be reduced, fewer optical elements may be required, and/or attenuation of light may be reduced due to a shorter optical path and/or fewer optical elements positioned in the optical path.

In particular, the lens 160 is configured to blur light so that light that is to be received by the optical sensor 124 is blurred (spread). For example, the lens 160 may be configured so as to provide sufficient blurring compared to other lenses in the ToF camera system 100 so as to achieve wide blurring at the optical sensor 124. The lens 160 may be configured to cause a predetermined spreading of light, parallel to the blurring axis 106, at the plurality of sensing locations (one or more of the pixels 126 or other sensing locations) to reduce light intensity, e.g. optical energy intensity. It is understood that in various embodiments, the lens 160 may be substituted or replaced with one or more lenses, one or more diffusers, one or more diffractive optical elements, and/or one or more other optical elements suitable to provide a predetermined spreading of received light, as described above. For example, predetermined spreading of light by the lens 160 may facilitate determining the direction of spreading of light and determining a region of interest for sensing blurred light with the optical sensor 124.

As referred to herein, a predetermined spreading of light by the lens 160 or another blurring element may refer to predetermined physical characteristics of the lens 160 or the other blurring element that lead to blurring of light received by the lens 160 or the other blurring element. For example, while the effect of the lens 160 on received light may remain predetermined, the actual blurred light (after the predetermined spreading) formed by the lens 160 or the other blurring element may vary depending on the oncoming light, e.g. the actual blurred light formed by the lens 160 or the other blurring element varies depending on the distance to the scene from the lens 160 or the other blurring element. In various embodiments, the predetermined spreading of light by a blurring element may refer to spreading of light by a blurring element with predetermined parameters.

Then lens 160 may be a unitary lens, a compound lens, or other arrangement of optical elements actings in concert as an optical blurring filter. Such an optical blurring filter may cause unidirectional spreading of light so as to cause blurring of light at the optical sensor 124.

The lens 160, in some embodiments, is configured such that the predetermined spreading of light in the blurring direction (along the blurring axis 106 or parallel thereto) is unidirectional spreading of light. For example, in some embodiments, the lens 160 is a cylindrical lens configured to cause spreading of light along the blurring axis 106 (or parallel thereto) while mitigating spreading of light perpendicular to the blurring axis 106.

The time-of-flight camera system 100 is operable to determine the distance to the target 120 based on sensed light at each of the plurality of sensing locations, the emitted light, and the predetermined spreading of the light by the lens 160 (or blurring element).

An image-forming objective 162 (also referred to as an objective lens) is optically positioned between the lens 160 and the optical sensor 124 such that the optical sensor 124 receives light via the objective 162. Positioning the objective 162 along a light path between the lens 160 and the optical sensor 124 facilitates forming a substantially focused image of the target on the optical sensor 124. For example, the objective 162 may be positioned geometrically between the lens 160 and the optical sensor 124.

The lens 160 and/or other blurring element(s) and the objective 162 together are configured to cause a predetermined spreading of light parallel to the blurring axis 106 at the plurality of sensing locations, such as the pixels 126 described above. In combination, the lens 160 and the objective 162 spread the reflected light 132 along the blurring axis 106 (or parallel thereto) to reduce the probability of saturation of portions of the optical sensor 124 and to improve dynamic range thereof. In some embodiments, the objective 162 is optically positioned between the lens 160, and/or other blurring element(s), and the optical sensor 124. For example, the objective 162 may be positioned geometrically between the lens 160, and/or other blurring element(s), and the optical sensor 124.

In some embodiments, the emitted light 130 forms a line of light substantially parallel to the line axis 104 such that the reflected light 132 is received by the optical assembly 121 so as to form a corresponding line of light directed generally towards the optical sensor 124. The optical assembly 121 blurs the reflected light by spreading it along a direction parallel to the blurring axis 106 while focusing the reflected light and mitigating blurring and spreading thereof in a direction parallel to the line axis 104. Consequently, the reflected light 132 that is blurred by the optical assembly 121 forms an imaged line on the optical sensor 124 for high-resolution imaging in the direction parallel to the line axis 104. The imaged line is elongated along an axis and is blurred in a direction parallel to the blurring axis 106.

In some embodiments, a ToF camera system 100 includes a direct time-of-flight (direct ToF) system or ranger, wherein the distance between the target 120 and the ToF camera system 100 is determined based on the product of the speed of light and the time duration between emission of optical energy from the light emitter 122 and reception of reflected optical energy by the optical sensor 124.

Indirect Time-of-Flight (iToF) image sensors (e.g. optical sensor 124 in some embodiments is an iToF image sensor) are used to measure depth and three-dimensional shape by projecting a modulated continuous-wave carrier signal onto a scene and measuring the phase delay of the return signal to calculate depth.

Referring to FIG. 2, the ToF camera system 100 includes an indirect time-of-flight (indirect ToF or iToF) system. The optical sensor 124, or in some embodiments other component(s) of the ToF camera system 100, is operable to demodulate the reflected optical energy to produce, for each pixel 126 of the optical sensor 124, a reflected signal that is comparable to the modulating signal over a time period, or number of periodic cycles of the reflected signal, associated with the previously selected exposure duration. However, the phase of the reflected optical signal corresponding to a given pixel 126 may be different from that of the modulating signal according to the distance travelled by the combined paths of the modulated optical energy and the reflected optical energy. By synchronizing the operations of the light emitter 122 and the optical sensor 124 and measuring the phase difference (phase delay) between the modulating and reflected signals corresponding to each pixel 126, the ToF camera system 100 is operable in some embodiments to determine a depth map of the scene within the field of view of the ToF camera system 100.

For each pixel in an image captured by the optical sensor 124, the phase delay of the reflected light can be calculated based on a plurality of correlations (or set of correlation measurements) of the reflected, sensed light at different phase angles relative to the emitted light.

One method is to use four correlations, e.g. measure four equally spaced correlation signals. In this case, each of the plurality of correlations is associated with a corresponding phase shift between the emitted light and the sensed light. e.g. correlation signals at 0, 90, 180 and 270 degrees phase angles relative to the emitted light. Denoting these four correlation signals c₀, c₁, c₂ and c₃. The depth (distance to the target 120) of the reflected light is calculated as:

$$d = \frac{s}{4 π {f}_{mod}} {tan}^{- 1} ( \frac{{c}_{3} - {c}_{1}}{{c}_{0} - {c}_{2}} ) \qquad [ 1 ]$$

where S is the speed of light, f_{mod} is the modulation frequency, c₀ is the correlation signal for the pixel at the 0 degrees phase angle, c₁ is the correlation signal for the pixel at the 90 degrees phase angle, c₂ is the correlation signal for the pixel at the 180 degrees phase angle and c₃ is the correlation signal for the pixel at the 270 degrees phase angle. It is often useful to measure the amplitude of the reflected light at each pixel in addition to its depth. For a 4-phase iToF system, amplitude can be calculated as:

$$A = \sqrt{{( {c}_{0} - {c}_{2} )}^{2} + {( {c}_{3} - {c}_{1} )}^{2}} \qquad [ 2 ]$$

It is understood that a different number of correlation measurements, or different phase delays, may be used to calculate depth with suitable changes to the equation used.

Time-of-flight optical sensors commonly measure depth at a single point or over a two-dimensional grid forming a two-dimensional depth image.

Typically, indirect ToF systems advantageously provide higher accuracy than direct ToF systems. However, due to phase wrapping, the maximum unambiguous range of an indirect ToF system is limited based on the modulation frequency of the emitted light 130. An indirect ToF phase measurement, when the phase delay exceeds 360 degrees (2π radians), ‘wraps’ back to 0 degrees. In other words, a phase delay of x degrees and x+2nπ degrees may not be distinguishable from each other without further steps, since the pulses will be overlapping for any integer value of n. In some cases, it is assumed that the distance will not exceed the maximum measurable distance based the modulation frequency dₘₐₓ and depth is calculated assuming n=0, i.e. all of the measured depth values fall in between 0 depth and the distance at which the returned phase wraps back to 0 degrees. If this approach is used and the depth of an object is measured and the object is physically further away than the maximum measurement distance dₘₐₓ, then the calculated depth is incorrect. Advantageously, aspects disclosed herein allow phase unwrapping to achieve a greater maximum unambiguous range.

In some embodiments, the optical sensor 124 includes two charge storage nodes for each pixel 126, and during exposure to the reflected energy switches between each half-pixel (not shown) at a rate corresponding to the frequency of the modulating signal. However, in general, any suitable optical sensor 124 may be employed.

The ToF camera system 100 in some embodiments includes a correlator 140 for determining, for each pixel 126, the mathematical correlation between the modulating signal (the emitted light 130) and the reflected signal (the reflected light 132) during the exposure duration as a phase-difference correlation, and digitally encoding the phase-correlation values to produce a phase-correlation image. As referred to herein, reflected signals include those that are sensed at certain pixels 126 only due to spreading of light by the optical assembly 121. In some embodiments, the function of the correlator 140 to produce the digitized phase-correlation values may be integral to the optical sensor 124.

In various embodiments, for each pixel 126 of the optical sensor 124, a corresponding correlation signal may be output directly from the optical sensor 124, e.g. without additional calculation. In some embodiments, the correlator 140 may achieve correlation calculations by analog means, i.e. without digitization. In some embodiments, within each pixel, a respective correlation(s) may be determined by the correlator 140. For example, such pixel-based correlation calculation may be carried out by an analog component (via an analog process).

In some embodiments, the correlator 140 may perform additional processing, such as applying mathematical weights or other mathematical functions to the phase-correlation values produced by or within the optical sensor 124. For example, the correlator may perform accumulating (e.g. sequentially or non-sequentially summing), averaging, or weighted averaging of the correlations based on the predetermined spreading of the light by the lens 160. For example, correlator 140 may average (or simply accumulate) correlations over only four pixels along a line if the lens 160 is configured to cause a substantially uniform four-pixel blur (spreading) of light along that line, i.e. the lens 160 is configured to cause light that would have been received by an isolated pixel to be spread over four adjacent pixels with commensurate reduction in light intensity. As such, the correlator 140 may reduce a two-dimensional array of correlations to a one-dimensional array of average correlations.

For example, if the reflected light 132 is spatially elongated so as to define a line, light may be sensed at a two-dimensional array of pixels 126 of the optical sensor 124. A first direction of the two-dimensional array may be substantially parallel to the line axis 104, and a second direction may be substantially parallel to the blurring axis 106. In various embodiments, a one-dimensional array of correlations may be achieved by averaging or accumulating the two-dimensional array along the second direction, i.e. by using averaging or accumulating the array along a dimension (or direction) associated with the blurring axis 106, to determine the distance to the target 120.

It is understood that the emitted light 130 and the optical assembly 121 may be complementary to each other such that spreading of light by the optical assembly 121 does not cause ambiguity in distinguishing the source of light sensed at a pixel 126. For example, light emitting in a line parallel to the blurring axis 106 may lead to such ambiguity.

The emitted light 130 may be a line of light directed to a plurality of locations on the target 120, non-parallel to the blurring axis 106 or lateral to the blurring axis 106, that is then received by the optical assembly 121 as reflected light 132 light that is reflected from the target 120 and defining a line, e.g. reflected from the plurality of locations on the target 120. The correlator 140 may then accumulate correlations (e.g. by averaging or weighted averaging) along the blurring axis 106 (or parallel thereto) to obtain a one-dimensional array of accumulated correlations. Such correlations may then be used to determine depth along a line on the target 120, e.g. using indirect time-of-flight methods. For example, data indicative of sensed light at each of the plurality of sensing locations (e.g. pixels 126) of the optical sensor 124 may be used to determine a one-dimensional distance array associated with the reflected light (and the line the reflected light defines) and indicative of corresponding distances of one or more objects in the scene.

The ToF camera system 100 may be operable to iterate the process of selecting a phase offset, modulating an optical carrier according to the phase offset, emitting the modulated optical energy, sensing at each pixel 126 the reflected optical energy, and determining phase-correlation values associated with the pixels 126. In variations of embodiments, this process may be iterated using the same or different exposure durations. Iterations of different phase offsets and different exposure durations may occur in any order.

With each new iteration or after multiple iterations, an accumulator 142 determines for each pixel 126 an accumulated correlation representing a sum of phase-correlation values. For example, the accumulator 142 may determine accumulated correlation(s) via accumulation of temporal sequence(s) of correlation values.

It is possible for a given phase-correlation value to be invalid. For example, the optical sensor 124 has a specifiable dynamic range such that a given pixel 126 will become saturated by excessive reflected optical energy. Also, the given pixel 126 may be inoperable or otherwise malfunctioning, the digital encoding of the pixel 126 output may be overloaded, or other computational errors may occur. A given phase-correlation value is considered invalid whenever its digital value is outside of a specifiable range. For example, in an 8-bit system, the digital value 11111111 is considered invalid as the true value is equal to or greater than the maximum value that can be produced in 8 bits and thus the true value is unknown.

The ToF camera system 100 may be operable to distinguish between valid and invalid phase-correlation values, and in some embodiments the accumulator 142 determines the accumulated correlation as a sum of only valid phase-correlation values. In some embodiments, a weighted and/or normalized sum of the phase-correlation values is employed.

A mask updater 144 updates an invalid-pixel mask to indicate which pixel positions of the depth map and amplitude image are invalid by association with invalid phase-correlation value(s). In some embodiments, the mask updater 144 is not employed, and other techniques for indicating invalid pixel positions are employed. For example, in some embodiments an invalid pixel position is assigned a special value, such as the maximum representable depth or amplitude value, to indicate an invalid pixel position. In some embodiments, invalid pixel positions are not tracked by the ToF camera system 100.

A depth-map generator 36 may be operable to generate the depth map in response to the accumulated correlations determined by the accumulator 142. In some embodiments, the depth-map generator 146 may generate the depth map in response to the accumulated correlations and the invalid-pixel mask determined by the mask updater 144. Invalid depth values may also be tracked by reserving and assigning a specific value to the depth, e.g. by using a corresponding maximum representable depth value for each chosen bit depth.

A normalizer 148 may be operable to generate a normalization mask useable to scale the accumulated correlations determined by the accumulator 142. The normalizer 148 may be an optional component that advantageously produces scaling factors for the amplitude image, such as to comply with limitations of digital displays used to present the amplitude image for human viewing (user viewing). In some embodiments, however, the normalization mask may be used to minimize or eliminate distortions in the amplitude image that are introduced by the accumulated correlations produced by the accumulator 142. In embodiments in which the normalization mask is corrective, the normalization mask may indicate for each pixel position a sum associated with all valid exposure durations, where an exposure duration is considered valid if it is associated with a valid set of phase-correlation values. A set of phase-correlation values is considered valid if all of the phase-correlation values contained therein are valid.

In a variation, the normalizer 148 may determine a sum of exposure-duration ratios in which each such ratio represents a ratio of a valid exposure duration and a reference exposure duration. The reference exposure duration may be the longest exposure duration selected by the exposure-duration selector 138, for example. In further variations, the normalizer 148 determines a weighted sum of valid exposure durations or a weighted sum of valid exposure-duration ratios. Other variations are possible.

An amplitude-image generator 150 generates the amplitude image in response to the accumulated correlations determined by the accumulator 142. The amplitude image can be scaled as desired for compatibility with any suitable display technique. In some embodiments, the amplitude-image generator 150 generates the amplitude image in response to the accumulated correlations and the normalization mask generated by the normalizer 148.

In some cases, it is found to be particularly advantageous to use a linear optical source, e.g. a line source such as a laser line generator, together with a two-dimensional time-of-flight light or image sensor as the optical sensor 124 to measure depth for points along a one-dimensional line (as projected) on the target 120. Advantageously, line scan imaging methods may be employed or adapted.

Still referring to FIG. 2, in various embodiments, a line-scan sequencer 152 line scans of the target 120. For example, a length, duration of emission, frequency, and other characteristics of a sequence of (spatially or temporally spaced apart) lines of light, non-parallel to the blurring direction, is determined and set by the line-scan sequencer 152. The light emitter 122 is configured to emit the sequence of spaced apart lines of light to generate reflected light sensed by the optical sensor 124 via the optical assembly 121 to define a corresponding sequence of imaged lines to facilitate line scanning of the target 120. For example, the light line is translated relative to the target (or object) between successive line image captures to build up a two-dimensional depth map, as described previously. As shown in FIG. 3, the line-scan sequencer 152 causes scanning movement 156. The scanning movement 156 may be movement of the target 120, the whole ToF camera system 100, and/or only of the line of light generated by the light emitter 122. In some embodiments, line scanning is achieved based on timing from a quadrature encoder attached to a motor, wherein the quadrature encoder triggers the ToF camera system 100 to capture a line image so that successive images have substantially equivalent amounts of translation.

In various embodiments, thicknesses and inter-line spacings of the sequence of spaced apart lines of light may be configured to achieve a desired spatial resolution. For example, each line may be thinner than an inter-line spacing to prevent overlap of lines. For example, the lines of light may be sufficiently thick to prevent gaps on the target 120 that are not sampled (hit with light) so as to obtain average or integrated (under-resolved) distances representative of the target 120.

In various embodiments, spatial sampling resolution of the two-dimensional depth map (and/or of the image) in the scanning direction (direction of motion) may be determined by the amount of translation between successive image captures.

In various embodiments, the one or more processors may be configured to determine a depth map based on a sequence of one-dimensional distance arrays determined based on a corresponding sequence of imaged lines. For example, in various embodiments the depth map may be a two-dimensional array.

Since the modulated emitted light in indirect ToF methods is periodic, the reflected light is also periodic and, as discussed above, an ambiguity may arise as to whether a given correlation between the emitted and reflected light is associated with a phase delay of x or with x+2nπ, for n>0. As such, a plurality of candidate distances to the target 120 result from a given phase delay, relative to the emitted light, of the reflected light.

A phase unwrapper 154 of the embodiment shown in FIG. 2 advantageously increases the maximum unambiguous range of the ToF camera. The light emitter 122 and the optical sensor 124 of this embodiment are laterally offset, in a direction perpendicular to the line axis 104, from each other relative to the target 120, e.g. spaced apart at least partially parallel to the blurring axis 106. Such an offset results in parallax when viewing the target 120 from the optical sensor 124 as compared to from the light emitter 122. The phase unwrapper 154 may compare (the line defined by) the reflected light to the line of emitted light to estimate a parallax associated with an image, e.g. parallax of a line in the image, defined by the reflected light. In some embodiments, a direct comparison may not be required. For example, parallax may be determined based on a geometry of the camera. For example, parallax may be determined based on an offset between the light emitter and the optical sensor, as described further below. The phase unwrapper 154 then determines the distance to the target using the plurality of candidate distances and the parallax of the (imaged) line associated with the reflected light, since a given parallax may be associated with a given distance or distance range. In general, the parallax effect is not sufficiently large to determine distances to the target 120 accurately. However, in various embodiments, distances estimated using the parallax effect are sufficiently precise to determine the number n>0 for which the actual distance lies within the range from x+2(n−1)π to x+2nπ. For example, in some embodiments, the parallax is sufficient to allow selection of a distance from the plurality of candidate distances. In some embodiments, parallax may also be used to directly correct distances. The embodiment of FIG. 1B may be particularly well-suited for achieving phase unwrapping based on parallax while the embodiment of FIG. 1A may be relatively ill-suited for achieving phase unwrapping based on parallax, e.g. in the embodiment of FIG. 1A, the parallax effect (distortion due to parallax) may be parallel to the line axis 104 and thus may not be discernible by the optical sensor 124, since reflected light may extend fully across the optical sensor 124 in the direction of the parallax effect.

In various embodiments, the ToF camera system 100 may be operable to generate a depth map, the camera system comprising a time-of-flight image sensor having a plurality of pixels, the camera system comprising a processor configured to: (a) determine, at each said pixel, a plurality of phase-correlation values associated with at least one exposure duration and at least one phase offset; (b) determine, for said each pixel, an accumulated correlation in response to the plurality of phase-correlation values; and (c) generate the depth map in response to a plurality of the accumulated correlations associated with the plurality of pixels.

While FIG. 2 shows the phase-offset selector 136, exposure-duration selector 138, correlator 140, accumulator 142, mask updater 144, depth-map generator 146, normalizer 148, amplitude-image generator 150, line-scan sequencer 152, and phase unwrapper 154 as various functional blocks of the computing device 600, indicating that each function is implemented as software-programming instructions stored within memory 604 (e.g. digital memory) of the ToF camera system 100 in communication with the one or more processors 602, in general any one or more of such functions is implemented in any suitable manner including as functionally equivalent discrete hardware components; one or more integrated circuits (IC), including being implemented by a monolithic integrated circuit (MIC), an Application Specific Integrated Circuit (ASIC), a Field Programmable Gate Array (FPGA), programmable logic controller (PLC), or similar; remotely accessible Software-as-a-Service (SaaS) in direct or indirect wired or wireless communication with the ToF camera system 100; or any combination thereof for example.

In some embodiments, there is provided a non-transitory computer-readable medium having stored thereon machine interpretable instructions which, when executed by a processor, cause the processor to perform one or (computer-implemented) method described herein. For example, such a medium (or media) may be removable and/or distributed, e.g. to be executed on distributed processors.

Thus, the ToF camera system 100 is operable to measure distance to a target in a scene, the ToF camera system 100 comprising a light emitter configured to generate emitted light elongated at least partially perpendicular to the blurring axis and directed towards the target to produce reflected light from the target; an optical sensor defining a plurality of sensing locations, at least partially distributed along a blurring direction, to sense the reflected light; a lens positioned between the optical sensor and the target so as to blur light that is to be received by the optical sensor via the objective, the lens configured to cause a predetermined (e.g. unidirectional) spreading of light in the blurring direction at the plurality of sensing locations to reduce light intensity at one or more of the plurality of sensing locations; one or more processors; and non-transitory, computer-readable memory coupled to the one or more processors and storing processor-executable (and/or machine interpretable) instructions that, when executed, configure the one or more processors to: receive data, via the optical sensor, indicative of sensed light at each of the plurality of sensing locations, and use the data to determine the distance to the target based on sensed light at each of the plurality of sensing locations, the emitted light, and the predetermined spreading of the light by the lens.

Referring to FIG. 2, the interface 190 may be an output or input only interface. In some embodiment, the interface 190 may be an input-output interface. In some embodiments, the interface 190 may be separate from and external to the ToF camera system 100 and connected thereto by a wired or wireless connection, e.g. operably connected to the one or more processor(s) 602. In some embodiments, the interface 190 may be connected to the ToF camera system 100 via a network connection. In some embodiments, the interface 190 may be integrated and may form part of the ToF camera system 100.

In some embodiments, the one or more processor(s) 602 may be configured to transmit data indicative of the depth to the interface 190. For example, a user may be made cognizant of the depth via the interface 190. In some embodiments, the one or more processor(s) 602 may further process the depth and provide the processed data to the interface 190. In some embodiments, a two-dimensional depth map may be displayed by the interface 190.

Referring to FIG. 2, the button 119 may be operably connected to the one or more processor(s) 602. In various embodiments, the button 119 may be used to provide an input to the ToF camera system 100. In various embodiments, the button 119 may be integrated into (and/or form part of) the ToF camera system 100 or may be separate and external to the ToF camera system 100.

For example, a user may interact with the interface 190 (e.g. via a touchscreen) and/or press the button 119 so as to cause execution of one or more methods by the processor(s) and/or to cause supply of power to one or more components of the ToF camera system 100.

It is understood that, in some embodiments, the one or more processor(s) 602 may provide depth measurement to an external server. For example, in some embodiments, the external server may be configured to cause execution of one or more methods based on the measured depth. For example, depths associated with manufactured parts on an assembly line may be monitored for quality control. For example, actions may be taken when the depth falls outside a predetermined threshold range. For example, one or more servers may generate an alert. For example, one or more servers may operate machinery based on the depth. For example, one or more servers may cause an alarm to be triggered, and/or stop a conveyer belt.

In some embodiments, the light emitter 122, the optical sensor 124, the objective 162, the lens 160 (or blurring element), the one or more processors 602, and the non-transitory, computer-readable memory 604 form an integrated camera assembly 103.

In some embodiments, the light emitter 122, the optical sensor 124, the objective 162, the lens 160 (or blurring element), and the one or more processors 602 form the integrated camera assembly 103 while the non-transitory, computer-readable memory 604 is external to the integrated camera housing assembly 103, but connected thereto.

In some embodiments, the light emitter 122, the optical sensor 124, the objective 162, and the lens 160 (or blurring element) form the integrated camera assembly 103 while the one or more processors 602, and the non-transitory, computer-readable memory 604 are external to the integrated camera housing assembly 103, but connected thereto.

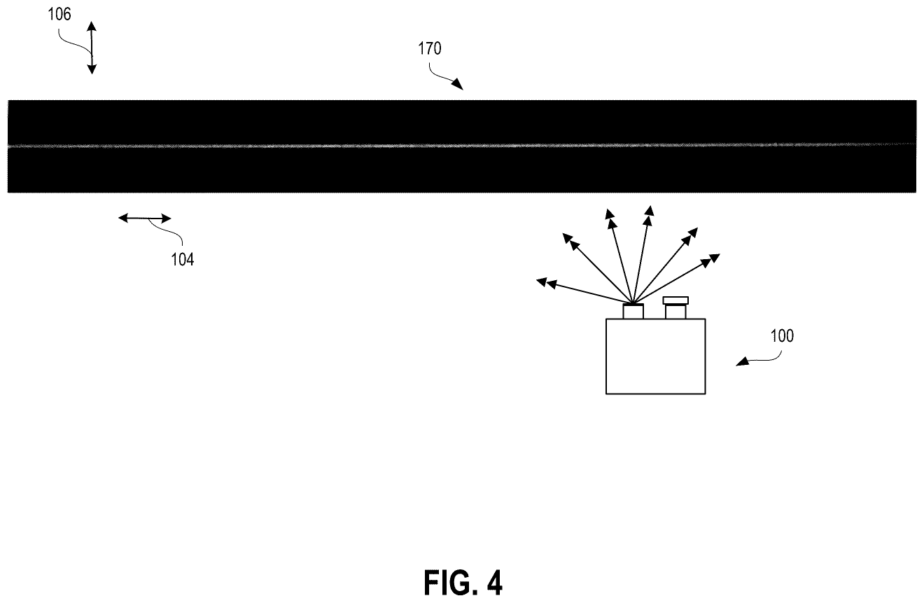

FIG. 4 shows a photograph of a light line 170 as projected by a laser line generator (an example light emitter 122) on to the target 120 by the ToF camera system 100, in accordance with an embodiment.

The ToF camera system 100, and representations of flow of the optical energy are shown schematically for reference.

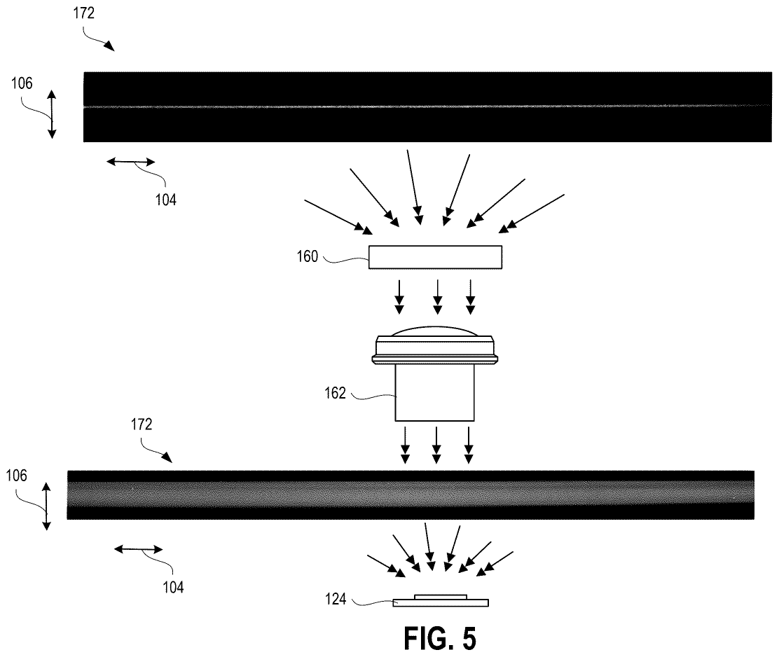

FIG. 5 shows a photograph of a blurred light line 172 as generated by the optical assembly 121, in accordance with an embodiment.

A photograph of the light line 170, the lens 160, the objective 162, the optical sensor 124, and representations of flow of the optical energy are shown schematically for reference.

Referring to FIG. 4, the emitted light forms a relatively narrow light line 170 projected on to the target 120. As shown in FIG. 5, the reflected light that reflects of off the target 120 is then blurred by the optical assembly 121 to form the blurred light line 172 that is relatively wide parallel to the blurring axis 106.

Advantageously, as shown in FIGS. 4-5, several pixel rows of the optical sensor may be utilized for the depth measurement of a single line in object space (a single line projected on to the target) by using the unidirectional (or one-dimensional) vertical optical blurring filter, e.g. a suitable cylindrical lens, to spread the reflected light 132 from the light line in a direction non-parallel, or lateral, to the light line along the optical sensor, e.g. for a horizontal line, the light may be spread vertically (parallel to the blurring axis 106) with optical blur.

Advantageously, since the resolution in the scanning direction may be determined by the amount of translation between image captures, the one-dimensional blur of the light imaged on the optical sensor 124 may not significantly degrade the resolution in the scanning direction so long as the line of light projected on to the target 120 is thin. For example, it may be preferable for the line thickness in object space to be comparable or smaller than the translation amount in the scanning direction between successive scans (line images).

Advantageously, as shown in FIG. 5, in some embodiments, using multiple sensor pixel rows to capture a single line of object space may increase the amount of light that may potentially contribute to a depth measurement. In some embodiments, improvement in the temporal noise of the depth measurement may be achieved. By blurring the light into multiple pixel rows, in some embodiments, the saturation capacity of the optical sensor may effectively be increased. In some embodiments, the number of photons captured for each line of object space (each line as projected on to the target 120) may be increased. In some embodiments, higher signal-to-noise ratios may be achieved. In some embodiments, the increased effective saturation capacity may be taken advantage of by increasing the intensity of the line illumination in object space, since the light intensity at the optical sensor 124 may be reduced due to blurring. For example, the intensity of the emitted light may be adjusted inversely proportionally to, or in another opposing manner in relation to, the reduction in light intensity at the optical sensor 124 due to blurring. For example, light intensity may be increased in proportion similar to the blur size in pixel units.

In some embodiments, the dynamic range of the system may be increased by using a non-uniform blur profile on the reflected line, so as to endow pixels with differing sensitivity so as to cause saturation of such pixels at differing object reflectivities. For example, this may allow less-sensitive rows to be used for stronger return signals while the more sensitive rows become saturated from too much light.

In various embodiments, the measurement range and/or depth resolution of the system may be increased beyond what is possible with normal time-of-flight depth measurement based on the measured position of the line on the optical sensor 124, taking the baseline between the light source and imaging lens into account (i.e. using the parallax to unwrap the time-of-flight phase measurements). This may allow the modulation frequency to be high which may provide high depth resolution without suffering from a limited non-ambiguous depth range. While traditional ToF sensors may exploit using two or more modulation frequencies to solve the depth resolution/ambiguous range trade-off, doing so requires capturing multiple depth frames and so may not be suitable for moving objects.

With a vertical optical blurring filter in place, the one or more processors is configured to use the data to determine distance data indicative of the distance to the target based on a plurality of accumulated (or averaged) correlations [symbol] (x). For example, in some embodiments, the distance data may include a representation of a numerical value of an estimated distance to the target in standard units. Each of the plurality of accumulated correlation [symbol] (x) may be associated with a corresponding phase shift, as described in reference to equation [1] above. Each of the plurality of accumulated correlations [symbol] (x) may be determined based on a corresponding plurality of correlations associated with the corresponding phase shift between the emitted light and the sensed light, i.e. cᵢ(x, y) for a plurality of locations y distributed along, and/or parallel to, the blurring axis 106.

For example, a set of summed correlation signals [symbol] , also referred to as a plurality of accumulated correlations, may be calculated by binning (summing or accumulating) the correlation values over all pixels at different rows in the same column, e.g.

$$= {\sum }_{y = {y}_{start}}^{{y}_{end}} {c}_{i} ( x , y ) \qquad [ 3 ]$$

In equation [3], the variable x refers to coordinates along a direction parallel to the line axis 104 and the variable y refers to coordinates along a direction parallel to the blurring axis 106. In equation [3], all the pixels in a column are added together without any weighting or consideration of their validity. Equation [3] reduces the correlation signals from a 2D array to a 1-D array, which may then be used to determine an associated 1-D depth array. In the case of a four phase system, equation [3] can be used four times to create for four columns sums [symbol] which can be input into equations [1] and [2] to calculate depth and amplitude for each column of pixels (pixels along or parallel to the blurring axis 106), giving an output 1D signal for each of depth and amplitude, i.e. depth(x), A(x).

For a fixed number of pixels, an averaged correlation may be proportional to a summation of the correlations along the pixels. The depth calculation according to equation [1] may then be invariant to the proportionality constant between the sum and the average.

If the return signal to the optical sensor 124 is very strong, the correlation signals from some pixels may become saturated to a maximum limit. This maximum limit may be the highest analog-to-digital (ADC) value if the ADC saturates before the pixel well, or it may be the ADC value that results from converting the maximum number of electrons that can be stored in a pixel well. In either case, the depth and signal amplitude calculated using a saturated correlation may not be valid as the true correlation signal may be higher than what is measured. If a unidirectional uniform optical blurring filter has uniform response over its extent, then all pixels in a column of the blurred line of light generally receive the same amount of light and so saturate at about the same time. Variations in signal strength may arise due to noise.

In some embodiments, each of the plurality of accumulated correlations [symbol] (x) is a weighted average of the corresponding plurality of correlations, the weighted average being based on weights at least partially determined by the predetermined spreading of light by the lens 160. For example, equation [3] may be modified to allow for general weights to be applied to each row, such as when a non-uniform optical blurring filter is used, e.g. to account for saturation

$${\hat{c}}_{i} ( x ) = {\sum }_{y = {y}_{start}}^{{y}_{end}} w ( x , y ) {c}_{i} ( x , y ) \qquad [ 4 ]$$

For example, the weights may be a function of, e.g. proportional to, an optical response of the lens 160 (and/or the optical assembly 121), which may characterize the predetermined spreading of light by the lens 160.

The starting row and ending rows in the sum above may be chosen to include all the pixels that receive light with the vertical optical blurring filter in place. It may be important to select as few extra dark rows outside the blurred line as possible. This summing of the blurred line over multiple rows may serve to increase the total full well capacity that contributes to the correlation measurement and may therefor increase its signal-to-noise ratio (SNR) if sufficient return light is available. Adding in signal from pixels that receive no light may add readout noise to the summed correlation signals without adding any useful signal to the sum. In some embodiments, it may be necessary to use a larger number of rows in the sum, many of which may not receive light, to account for variation in the line position from disparity (e.g. to facilitate using parallax for phase unwrapping), and possible rotation error of the line relative to the pixel grid.

It is understood that the same weights w(x, y) may need to be applied to each correlation signal cᵢ(x, y) (for all i) (associated with different phase angles) at a given pixel location (x, y), to avoid errors in calculating depth from the set of correlation values. The weights w(x, y) are a function of the pixel position but may not be a function of the correlation image number i.

In various embodiments, a variety of methods may be used to calculate the weights w(x, y) in equation [4]. If any correlation values at a pixel location are invalid from being saturated or other means, the weight of those pixels may be set to zero to exclude them from the summed correlation signals ĉᵢ(x). In the case of a four-phase time-of-flight measurement where a correlation value is deemed saturated if it is greater than a threshold tₛₐₜ, the weighting calculation may be given by:

$$w ( x , y ) = \{ \begin{matrix}0 , & if {c}_{i} ( x , y ) > {t}_{sat} for any i = 0 , 1 , 2 , 3 \\ 1 , & otherwise\end{matrix} \qquad [ 5 ]$$

In the equation [5], a pixel is determined to have a saturated correlation value by comparing the correlation values from the pixel to a set threshold, but other means of flagging saturated or invalid pixels are also possible. For example, some TOF image sensors may readout a special ‘invalid data’ code when a pixel is saturated, in this case the weights in equation [5] may be set based on comparing the values readout from the sensor for a pixel to the known code.

The weights used in equation [4] may also be calculated dynamically based on the signal level to minimize noise in summed correlation signals ĉᵢ(x). When multiple noisy signals are combined, a weighting scheme that is particularly effective to reduce noise in the weighted and summed output may be inverse-variance weighting.

In various embodiments, the two principal noise sources in pixels value readout from an image sensor may be (a) shot noise, which is proportional to the number of electrons accumulated at the pixel, and (b) readout noise. which is independent of the signal level. In some embodiments, the conversion gain K in units DN/e- (analog-to-digital units), and temporal dark noise σ_{d}, in units of electrons, may be calculated by characterizing the image sensor pixels 126 using photon transfer curve (PTC) analysis.

Summing up the four correlation signals for a pixel gives the total response of the pixel in units of DN:

$${c}_{total} ( x , y ) = {c}_{0} ( x , y ) + {c}_{1} ( x , y ) + {c}_{2} ( x , y ) + {c}_{3} ( x , y ) \qquad [ 6 ]$$

Dividing total response of the pixel in units of DN by the conversion gain (K) converts the amount of signal to the total number of electrons measured across the correlation measurements for the pixel at location (x, y) (or electron count at that location):

$$e ( x , y ) = {c}_{total} ( x , y ) / K \qquad [ 7 ]$$

Photon shot noise follows a Poisson distribution, and therefore has the property that the mean number of electrons is equal to the variance of the number of electrons. As such, e(x, y) may be both the mean and variance of the shot noise. The total noise variance may be the shot noise variance plus the temporal dark noise variance (usually a constant for all pixels across the image sensor). The optimal weight for the pixel, based on the signal-to-variance ratio, is then calculated as:

$$w ( x , y ) = \frac{e ( x , y )}{e ( x , y ) + {σ}_{d}^{2}} \qquad [ 8 ]$$

The temporal dark noise variance in equation [8] may be the temporal dark noise of the summed correlation signal cₜₒₜₐₗ, which may be four times the temporal dark noise variance of an individual correlation measurement c₀ . . . c₃.

In the case of rows where the shot noise is much larger than the temporal dark noise

$$( that is , e ( x , y ) ≫ {σ}_{d}^{2} ) ,$$

the weights approach 1.0. In the case where the temporal dark noise is much larger, the weights become proportional to the signal level e(x, y). Equation [8] is calculated using units of electrons but the same weighting may be calculated in units of DN through appropriate scaling.

In embodiments in which all the correlation measurements being combined are first scaled to have equal total amount of correlation signal (but different amounts of noise variance) prior to applying equation [8], then use of equation [8] can be considered an instance of inverse-variance weighting.

The dynamic weight calculation of equation [8], based on signal-to-variance ratio, may be combined with setting the weight of saturated pixels to zero to both exclude pixels invalid from saturation and improve SNR.

$$w ( x , y ) = \{ \begin{matrix}0 , & if {c}_{i} ( x , y ) > {t}_{sat} for any i = 0 , 1 , 2 , 3 \\ \frac{e ( x , y )}{e ( x , y ) + {σ}_{d}^{2}} , & otherwise\end{matrix} \qquad [ 9 ]$$

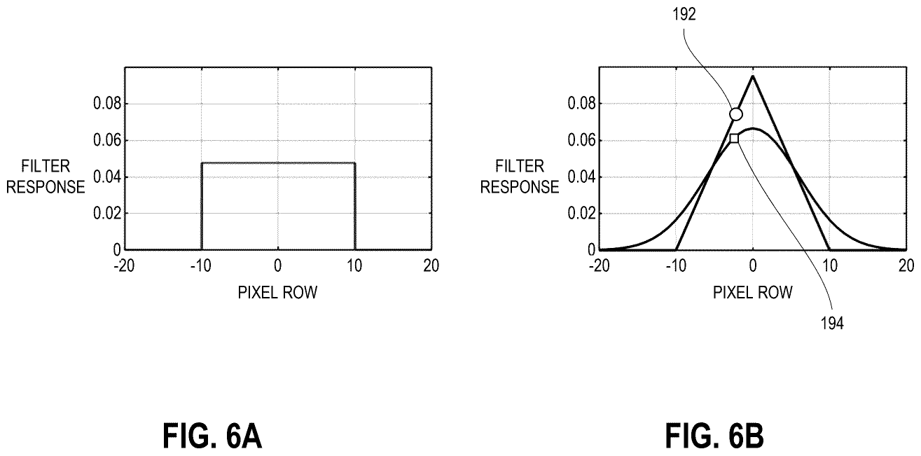

FIG. 6A is a first optical blurring filter response indicative of a first predetermined spreading of light by the lens 160, in accordance with an embodiment.

FIG. 6B are second and third optical blurring filter responses indicative of respective second and third predetermined spreading of light by the lens 160, in accordance with another embodiment. The second optical blurring filter response is annotated with a circle marker 192 and the third optical blurring filter response is annotated with a square marker 194.

The first, second, and third optical blurring filter responses may be associated with three different types of lenses, referred to as the first lens, second lens, and third lens.

The x-axes in the graphs in FIGS. 6A-6B are labeled ordinates of rows of the pixels 126 of the optical sensor 124 centred at the notional location of the reflected line on the optical sensor 124 in the absence of a blurring optical lens 160, i.e. the x-axis corresponds to locations along or parallel to the blurring axis 106. Each row of pixels indicated by the ordinates in FIGS. 6A-6B is associated with a row of pixels at least partially perpendicular to the blurring axis 106. The y-axis in the graphs in FIGS. 6A-6B represents the optical gain resulting from passage of light through the lens 160 and/or the optical assembly 121. As shown in FIGS. 6A-6B, the lens 160 reduce the light intensity at the pixels 126. In the absence of the lens 160, the reflected line pixel may be sensed only at a pixel row centered at the zero ordinate, e.g. the optical blurring filter response may be unity at this pixel row and zero elsewhere.

While the optical blurring filter (the lens 160 and/or the optical assembly 121) provides an analog response, the optical sensor 124 senses light filtered by the lens 160 in a discrete manner.

Referring to FIG. 6A, the first lens 160 may generate substantially uniform blurring symmetrically across a predetermined width around the reflected line. The first lens 160 may be configured to cause a predetermined, unidirectional, and substantially uniform spreading of light along or parallel to the blurring axis 106 at the plurality of sensing locations (pixels 126).

Referring to FIG. 6B, the second lens 160 may generate non-uniform blurring symmetrically across another predetermined width around the reflected line.

Referring to FIG. 6B, the third lens 160 may generate non-uniform blurring symmetrically across yet another predetermined width around the reflected line.

The second and third lens 160 may be configured to cause a predetermined, unidirectional spreading of light along or parallel to the blurring axis 106 at the plurality of sensing locations (pixels 126).

The optical blurring filter responses in FIGS. 6A-6B may be used to determine weighting in a weighted average.

While a uniform optical blurring filter, similar to the first lens whose optical response is shown in FIG. 6A, may be used, the dynamic range of the system may be improved by using non-uniform optical blurring filters where there is variation in intensity across the filter width, such as the second and third lenses whose optical responses are shown in FIG. 6B.

Achieving various optical responses is possible. An optical response where the highest or largest response is at pixels near center and where the response decreases gradually towards the tails of the filter is particularly advantageous for dynamic range and convenient to implement. The second and third lenses, whose optical responses are shown in FIG. 6B, achieve such behaviour. It is understood that other types of lenses and optical responses may be achieved as well.

Thus, the predetermined spreading of light by the lens 160 along or parallel to the blurring axis 106 may include non-uniform spreading of light along or parallel to the blurring axis 106 to mitigate sensor saturation of the optical sensor 124 by non-uniformly reducing light intensity along or parallel to the blurring axis 106.

Optical responses like those in FIGS. 6A-6B may allow the depth to be calculated with expanded dynamic range. When the return light signal (reflected light sensed by the optical sensor 124) is very strong the pixels near the center may saturate and be ignored, while the less sensitive pixels near the tails of the filter may be used for calculating depth. This may be helpful for measuring the depth of specular highlights on shiny objects as well as measuring retroreflectors. For darker objects, where no rows are saturated, all the pixels receiving light may be summed to achieve lower noise. Allowing valid depth to be calculated from the tails of the filter may potentially allow a system to receive more reflected light than might otherwise be possible or practical if the system is such that the saturated pixels needed to be avoided all together to measure valid depth. It is understood that the return signal can be increased by different means such as raising the exposure time, increasing the light source power through higher current or using multiple light sources in parallel, or using a lens with a larger aperture.

With the non-uniform optical responses shown in FIGS. 6A-6B, even if no pixels are saturated from over exposure, it may be advantageous to combine the rows with variable weighting to achieve better signal-to-noise ratios. The less sensitive pixels near the tails of the filter may have worse signal-to-noise ratios since they receive a lower fraction of the returned light for the row than the more sensitive pixels near center.

Equations [1] and [2] show how to calculate depth and amplitude based on a set of correlation measurements. An arbitrary set of weights w(x, y) can be used to combine the pixels at different rows with equation [4], and equation [1] may still produce valid depth when applied to the summed correlation signals [symbol] (x), regardless of exactly what the weights were. Nevertheless, the weights used may modify the amplitude signal calculated with equation [2], particularly if some weights are set to 0, excluding what may be the brightest rows from the amplitude calculation. In many cases, it may be desirable to calculate a linear or approximately linear amplitude signal along with depth, which may be used for different purposes such as identifying features based on amplitude edges or generating a point cloud with coloring that depends on the amplitude.

A method to correct for the weighting used when summing the rows of correlation signals may including normalizing the calculated amplitude based on the weight sum ŵ(x):

$$\hat{w} ( x ) = {\sum }_{y = {y}_{start}}^{{y}_{end}} {w}_{i} ( x , y ) \qquad [ 10 ]$$

For example, the amplitude may be provided as:

$${A}_{w} ( x ) = \frac{\sqrt{{( {\hat{c}}_{0} - {\hat{c}}_{2} )}^{2} + {( {\hat{c}}_{3} - {\hat{c}}_{1} )}^{2}}}{\hat{w} ( x )} \qquad [ 11 ]$$

Equations [10] and [11] account for variation in signal level coming from weight variations between rows, but do not correct for the reduction in amplitude coming from saturated pixels having zero weight. To address saturated pixels, a count of the number (cardinality) of saturated pixels that were set to zero weight, N(x), may be calculated for each column:

$$N ( x ) = {\sum }_{y = {y}_{start}}^{{y}_{end}} 1 , if {c}_{i} ( x , y ) > {t}_{sat} for any i = 0 , 1 , 2 , 3 \qquad [ 12 ]$$

With this count of saturated rows at each column, the amplitude calculated with equation [11] may be corrected by applying a gain that is a function of the number of saturated rows:

$${A}_{cor} ( x ) = {A}_{w} ( x ) * G ( N ( x ) ) \qquad [ 13 ]$$

The function G(N) may depend on the optical response profile. The function G(N) may be implemented as a look-up table (LUT) as it may only need to operate on natural numbers up to the number of rows that are combined in equation [4]. In general, G(0)=1, and G(P)>1 for P>0.

With a known optical response profile b(r), G(N) may be calculated based on how much of the total response is lost by removing the N most sensitive rows.

$$G ( N ) = \frac{sum b ( r ) over all rows}{sum b ( r ) over rows excluding N most senstive ones} \qquad [ 14 ]$$

A complication that may arise calculating G(N) in this way is the blur profile may vary based on the object distance due to focusing effects of the vertical blur optics. In some embodiments, the amplitude gain may be made to be a function of both the number of saturated rows (N) and the object distance (or disparity/line location).

As discussed previously, the depth obtained using indirect time-of-flight methods may suffer from a limited unambiguous range or may lead to a plurality of equi-spaced candidate depths. A single, unambiguous depth may be selected from the plurality of equi-spaced candidate depths (associated with 2nπ phase shifts, for natural number n>0) to achieve a larger unambiguous range by using parallax of a line of light projected on to the target 120.

It is understood that parallax of a line may depend on depth. For example, in a scene with varying depth, a line may be subject to different amounts of parallax. For example, if the depth varies discretely or is sensed in such a manner, an imaged line may be perceived to comprise a plurality of segments, e.g. discontinuously sequentially inter-connected, each segment being a line subject to parallax associated with a particular depth. For example, if the depth is smoothly varying, the parallax along the imaged line may vary smoothly.

When the offset 176 is non-zero, for a line of light projected on to the target 120, the vertical position (i.e., the pixel row, or position along or parallel to the blurring axis 106) of the line in the image formed on the optical sensor 124 may vary depending on the distance to the object reflecting the light back to the camera system, or optical sensor 124 thereof, due to parallax arising because of a non-zero angle between the emitted light and the reflected light.

Parallax may be characterized by disparity. The disparity is the difference between the apparent position of an object at a finite distance y_{d} and the apparent position of the object at a theoretical infinite distance y_{∞}, i.e. y_{d}−y_{∞}. The infinite distance y_{∞} may be defined as the image row that an infinitely far object would appear at. The disparity for an object at some distance Z away from the ToF camera system 100, or optical sensor 124 or light emitter 122 thereof, may be given by the formula:

$${y}_{d} - {y}_{∞} = \frac{fB}{Z} \qquad [ 15 ]$$

where f is the camera's focal length measured in units of pixels and is typically a known constant, B is the offset 176 between the lens and line generator and is typically a known constant, and Z is the distance to the object. For example, known constants may be determined based on lens datasheets and mechanical design, or through means of a camera calibration procedure. Camera calibration techniques may also be used to determine y_{∞} once, which may then allow it to be treated as a known constant. The object distance Z coordinate may then be calculated based on the time-of-flight correlation measurements up to an unknown multiple of the maximum distance for the modulation frequency dₘₐₓ using equation [1].

Defining this base distance with no phase wrapping past 360 degrees as d₀. The Z distance may be expressed as:

$$Z = ( {d}_{0} + n \cdot {d}_{max} ) cos W \qquad [ 16 ]$$

The value of n in equation [16] is an unknown integer greater than or equal to 0, and W is the angle between the pixel ray and the lens optical axis which can be calculated once ahead of time using standard camera calibration techniques and treated as a known constant during operation. In some cases, such as a lens with a relatively narrow field-of-view, it may be sufficient to assume W is approximately zero and cos W≈1 in equation [16].

The row position of the center of the laser line may be used for y_{d} in equation [15] and may be determined from images of the line. For example, y_{d} may be calculated based on the center-of-mass of the total correlation signal, cₜₒₜₐₗ(x, y) from equation [6].

$${y}_{d} ( x ) = \frac{{\sum }_{y = {y}_{start}}^{{y}_{end}} y \cdot {c}_{total} ( x , y )}{{\sum }_{y = {y}_{start}}^{{y}_{end}} {c}_{total} ( x , y )} \qquad [ 17 ]$$

Note y_{d} may be different for every column in the output line depth line, as different columns can have different measured depths.

With an estimate of the center of the laser line, y_{d}(x) and a calculated base depth d₀, the number of phase wraps consistent with the observed disparity may be calculated by combining equations [15] and [16]:

$$n = \frac{( \frac{fB}{{y}_{d} - {y}_{∞}} - {d}_{0} cos W )}{{d}_{max} cos W} \qquad [ 18 ]$$

The value of n obtained using equation [18] may be non-integer, in some cases. In this case, the value of n calculated with [18] may be rounded to the nearest integer greater than or equal to zero. In some embodiments, the value of n may be restricted to some reasonable range, as for larger values on n, the change in disparity from incrementing n by 1 becomes smaller and smaller, approaching 0 as n goes to infinity. As the change in disparity becomes small it may become hard to measure the center of line precisely enough to tell apart close values of n, particularly since the return signal from the light source gets weaker and nosier as distance is increased. Therefore, the value of n calculated with [18] may be limited to a small set such as (0, 1) or (0, 1, 2). With the value of n determined, the measured depth for the column may be calculated as:

$$depth = {d}_{0} + n \cdot {d}_{max} \qquad [ 19 ]$$

As described earlier, in various embodiments, fB and cos W may be known constants from system calibration, the disparity (y_{d}−y_{∞}) may be calculated from the line center-of-mass, and dₘₐₓ may be a known constant calculated from the modulation frequency. As such, n may be the only unknown in the equation that needs to be solved for. With a small set of possible values for n, the left side of equation [19] may be calculated for each possible value, choosing the value on n that makes the left side of [19] closest to the known constant value fB.

In some embodiments, a set of thresholds for different values of n may be computed and then compared to the constant fB. From equation [19], it is known that the product of disparity times depth converted to Z coordinate gives the constant value fB. For a given disparity value, all possible depth values lower than the true value will give a product below fB, and all depth values above the true value will give a product above fB. With this observation a set of potential depth values may be tested, starting for low values of n and increasing it until the candidate depth has become too large according to [19]. There will be some noise in both the measured disparity, (y_{d}−y_{∞}), and the measured zero-wrap base depth d₀, so instead of testing exact multiple of n, points in between the possible values may be tested, for example n=0.5, n=1.5, etc.

For example, suppose the maximum value of n for the system is two, i.e. parallax-based unwrapping using disparity may be used to extend the measurable depth range by three times. In this case, the following threshold may be defined:

$${T}_{n = 0} = ( {y}_{d} - {y}_{∞} ) \cdot ( {d}_{0} + 0.5 \cdot {d}_{max} ) cos W \qquad [ 20 ]$$

$${T}_{n = 1} = ( {y}_{d} - {y}_{∞} ) \cdot ( {d}_{0} + 1.5 \cdot {d}_{max} ) cos W$$

These calculated thresholds may be compared to the known constant fB as follows:

if (Tₙ₌₀> fB): then n = 0;
else if (Tₙ₌₁> fB): then n = 1;
else: n=2

For example, if n=0.5 gives a value of depth that is too large based on equation [19], n must be 0 since it must be a non-negative integer. For example, if n=0.5 gives a value of depth that is too small and n=1.5 gives a value of depth that is too large (according to equation [19]), then n must equal 1 since it must be an integer. The final condition is setting n to 2 as that is the chosen maximum number of wraps for the system and it has been determined that n is greater than 1.5 if the final ‘else’ condition is reached. This approach could be applied for any maximum value of n using a set of n−1 threshold comparisons. Equation [20] may be used for testing potential depths exactly in between potential candidate depths, but the thresholds may be calculated using any values in between the integers, for example between 0 and 1.0 for the first threshold, any value between 1.0 and 2.0 for the second threshold, and so on. It may be desirable in some cases to bias the comparison for choosing either a lower or higher value of n for a given measured disparity by choosing midpoint values closer to one side of the range. In some situations, prior knowledge of a scene may indicate the likelihood of achieving a variety of depths, e.g. depths within a given range may be much more likely than depths outside the same or another range. In various embodiments, such prior knowledge may facilitate biasing towards measurements that have higher likelihood. In some situations, the impact or consequence of errors might also vary depending on depth and application. For example, false close depth errors may have worse impacts on a system like robot navigation than false far depth errors. In various embodiments, the biasing may be based on the predicted outcomes.

The lens 160 may be composed one or more types of optical element(s) that may be used to create a one-dimensional (unidirectional) blur or spread of light while mitigating blurring or spreading of light in other directions.

It is particularly advantageous that the lens 160 have a one-dimensional point spread function, so as to achieve blurring in one direction without any residual blurring in a direction perpendicular to the blurring axis 106. However, it is understood that practical lens arrangements and optical elements may not achieve perfectly unidirectional blurring. As such, it is desired to have sufficiently unidirectional blurring to achieve desired precision and accuracy. For example, low residual blurring in the direction perpendicular to the blurring axis 106 may facilitate maintaining the resolution of the imaging system with respect to depth measurements of the target 120 along a line of light projected on the target 120 and perpendicular thereto. It is desired that the point spread function is invariant or only slightly varies with position along the line of light.

It is found to be particularly important that the lens 160 have sufficiently low veiling glare and scattering such that bright areas of the image do not spread their light over darker image areas to hamper accuracy and precision. For example, depth accuracy for distant and or low reflectivity objects may require low veiling glare and scattering.

In various embodiments, a blurring element may include one or more cylinder lenses, acylinder lenses, one-dimensional free-form lenses, one-dimensional microstructured diffusers, and/or one-dimensional diffractive optical elements.

It is found to be advantageous to use a cylindrical lens for the lens 160. Such lenses may be particularly cost effective, easy to fabricate, and may demonstrate low reflection and scattering.

Advantageously, it is found that a highly unidirectionally spreading lens (associated with a one-dimensional blur function) may be achieved by placing a cylindrical lens in front of the objective 162 of the ToF camera system 100, since the objective 162 may be configured with a large aperture (small f-number) to achieve a desired sensitivity of the ToF camera system 100.

Due to the large aperture, the objective may generate relatively large ray angle angles at the exit thereof within plane(s) parallel to the blurring axis 106. As such, to avoid aberrations, the objective 162 may be placed between the lens 160 (in the form of a cylindrical lens according to some embodiments) and the optical sensor 124. In various embodiments, the target 120 is much farther away from the objective 162 compared to the focal length of the objective 162, e.g. 50 times the focal length. It is understood that the far distances make the rays landing on the lens 160, e.g. a cylindrical lens, approximately parallel (in the plane of the blur), which may provide a highly one-dimensional blur across the full length of a line image.

In various embodiments, the lens 160 may be, or may be composed of one or more of, a cylindrical lens, a plano-concave lens, a plano-convex lens, a bi-concave lens, and/or a bi-convex lens.

In various embodiments, it was found that the piano type cylindrical lenses may be particularly advantageous. For example, such lenses may be more cost effective. For example, such lenses include a flat surface which can be made to face away from the camera system or optical sensor thereof, which flat surface may be particularly advantageous for sealing to the camera housing to provide water and dust ingress protection, e.g. IP67 without introducing an additional window to the optical path and therefore avoiding additional scattering and reflection.

It is found that, while both concave and convex cylindrical lenses may be used in the lens 160, an advantage of the concave lens (plano-concave or bi-concave) is that it may result in the lens 160 and the objective 162 together being focused beyond the focus distance of the objective 162. This may be particularly advantageous since ToF cameras are commonly expected to have a fixed focus distance.

For example, if the objective 162 is focused at two meters without the lens 160, the ToF camera may remain focused at two meters in the direction perpendicular to the blurring axis 106 when the lens 160 (as a cylindrical lens) is included in the optical assembly 121, i.e. parallel to the line axis 104. However, the lens 160 may introduce blur from defocus parallel to in the blurring axis 106. The camera's focus distance parallel to the blurring axis 106 may then be greater than two meters, and may even be past infinity depending on the desired amount of blur. With this arrangement, an object closer than two meters may result in increased blur parallel to the blurring axis 106 while an object farther than two meters will result in relatively reduced vertical blur. Since closer objects may receive higher irradiance from the line of light, the increased blur parallel to the blurring axis 106 at close distances may distribute the light on the optical sensor 124 across more pixel rows. As such, the likelihood of saturation may be reduced and signal-to-noise may be increased, since there may be a reduced need to discard away saturated pixels. For farther object distances, the blur along or parallel to the blurring axis 106 decreases resulting in the light being concentrated into fewer pixel rows. Advantageously, this may reduce the number of rows that need to be summed which may reduce the amount of temporal dark noise.

In various embodiments, it is found that the amount of blur that is obtained may be a function of the optical power of the one-dimensional lens 160. In various embodiments, the approximate blur size at the focus distance of the objective 162 may be calculated from the effective focal length of the lens 160 and objective 162 as a pair by summing their optical powers (e.g. inverse of focal length). In various embodiments, knowing the distance at which the objective 162 is focused without the lens 160 may allow determination of the image location for the objective by itself, e.g. by using the Gaussian or Newtonian thin lens equations. A new image distance that will result from the effective focal length of the objective 162 and lens 160 together may then be determined. In various embodiments, using trigonometry, an approximate extent for the blur may be determined based on the difference between the image distances with and without the lens 160 combined with the f-number.

In various embodiments, the choice of concave or convex cylindrical lenses may also influence the shape of optical response of the lens 160 and/or optical assembly 121. In various embodiments, it may be possible to tailor the shape of the optical response of the lens 160 and/or optical assembly 121 with acylindrical lenses as well as free-form one-dimensional lenses. For example, a more ramped optical response profile of the lens 160 may be achieved. For example, the optical response profiles shown in FIGS. 6A-6B of the lens 160 may at least approximately be achieved. For example, optical responses of the lens 160 resembling a gaussian or triangular shape, to achieve greater dynamic range, may be achieved. In various embodiments, regardless of the particular shape of the lens 160, the optical power of thereof is preferably negative (diverging) so that the amount of blur increases for nearer object distances.

In various embodiments, it is found that the particular shape of the optical response may be affected by specific aberrations (if any) of the objective 162 their interaction with aberrations (if any) of the lens 160. In various embodiments, the optical response and behaviour of a lens may be measured to determine if the lens is suitable for high-dynamic range processing.

In various embodiments, the blurring behaviour of the lens 160 and the objective 162 may be simulated, e.g. with ray tracing software, to determine the optical response. For example, the lens 160 and/or the objective 162 may be modified, e.g. by combining with other optical elements or shaping, based on a simulation of the lens 160 and the objective 162 and to achieve a predetermined spreading or optical response.

In various embodiments, collection of multi-path light (e.g. due to inter-scene reflections) may lead to undesirable errors and/or reduction in accuracy and/or precision. In various embodiments, the amount of blurring may be determined based on a target use (or application) of the ToF camera system, e.g. based on a predetermined use-specific tolerance for depth errors.

In various embodiments, the amount of multi-path light reflected and or scattered in the scene that will overlap with the blurred line image on the image sensor may depend on the width and intensity of blurring caused by the lens 160, or the point spread function or blur function of the lens 160. For example, each sensor pixel may see only the portion of the target 120 perpendicular to a reflected line of light as long as the only modulated light illuminating the object is the direct path of the line. However, if the target 120 or scene reflects some of the emitted light's power above or below (the imaged line defined by) the reflected light but still within the width or support of the optical response (the width of the blur) seen by the pixel, then the pixel may include multi-path light and may suffer some depth error as a result. Multi-path errors are systematic and generally cannot be removed by averaging or increasing power of the emitted light. In various embodiments, it is therefore not advisable to increase the amount of blur beyond what is required to achieve the desired noise performance.

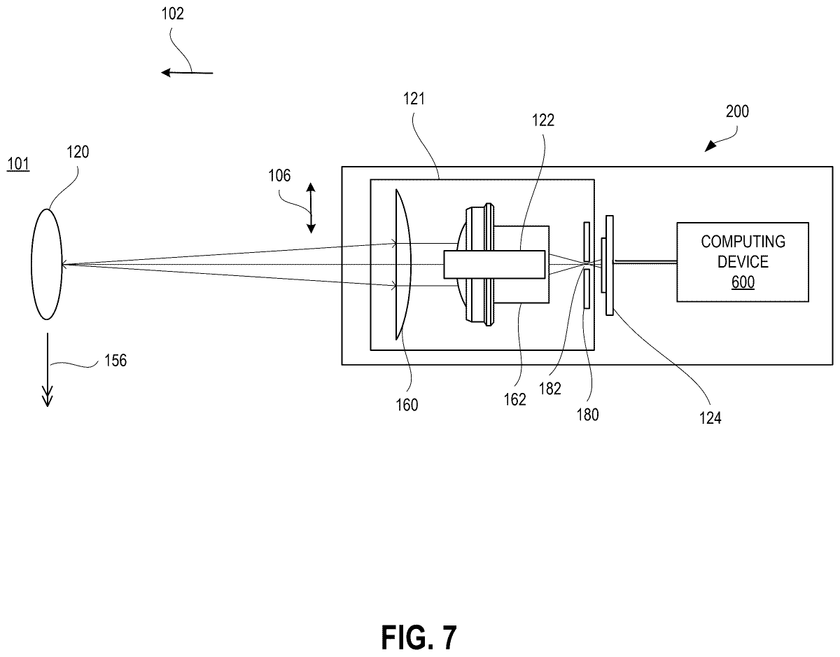

FIG. 7 is a schematic representation of a ToF camera system 200 illustrating example light rays as they travel through the ToF camera system 200, in accordance with another embodiment.

The optical assembly 121 in the ToF camera system 200 may include a screen 180 defining a slit 182 positioned thereon. The screen 180 may be optically positioned between the objective 162 and the optical sensor 124 to block light reaching the pixels 126 from the objective 162. For example, the screen 180 may be positioned geometrically between the objective 162 and the optical sensor 124. The objective 162 may be configured to allow passage of the reflected light through the slit 182. The light emitter 122, the objective 162, and the lens 160 may be configured to form an intermediate image plane at the slit 182. Such a configuration may advantageously reduce collection of multi-path light.

The light emitter 122 may be positioned so that the objective 162 lies in the plane of the laser line (i.e. perpendicular to the page as shown and parallel to the line axis 104) to eliminate disparity in a line image resulting from different object distances. This ensures that for any object distance, the image of the line is able to pass through the slit opening in the spatial filter. A piano-convex lens may be used to form an image of the line in front of the optical sensor 124. The slit 182 may be placed at the intermediate image to allow light originating from the line on the target 120 to pass through the slit 182.

Multi-path light that bounces from the target 120 to other points above or below the line of light may be rejected by the slit 182. Multi-path light that remains within the plane of the line of light may still be detected by the optical sensor 124. However, this fraction may be a relatively small fraction of the total multi-path light in the scene.

In various embodiments of such a method, using parallax to unwrap the phase angle of the return light may not be possible. As such, a lower unambiguous distance range may result, or higher noise, due to use of a lower modulation frequency.

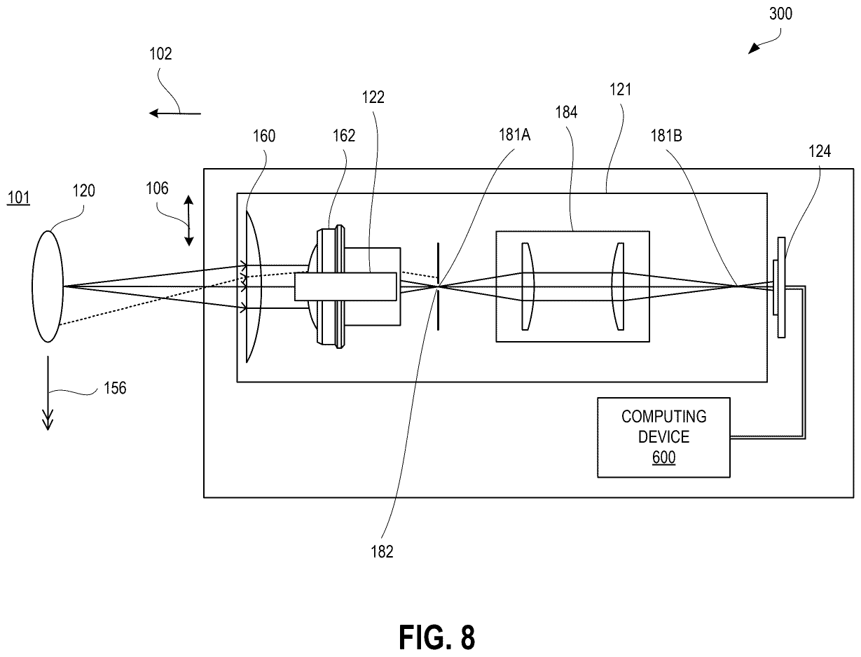

FIG. 8 is a schematic representation of a ToF camera system 300 illustrating example light rays as they travel through the ToF camera system 300, in accordance with yet another embodiment.

The ToF camera system 300 may include a screen 180, defining a slit 182, optically positioned between a relay lens 184 and the optical sensor 124 to block light reaching the pixels 126 from the objective 162. For example, the screen 180 may be positioned geometrically between the relay lens 184 and the optical sensor 124 to block the light. An example light ray blocked by the slit 182 is shown in FIG. 8 using dotted lines.

The light emitter 122, the objective 162, and the lens 160 may be configured to form an intermediate image plane 181A at the slit 182. The relay lens 184 is optically positioned between the intermediate image plane 181A and the optical sensor 124. For example, the relay lens 184 is positioned geometrically between the intermediate image plane 181A and the optical sensor 124. The relay lens 184 may be configured to allow passage of the reflected light therethrough to form another image plane 181B (a conjugate image plane).

Advantageously, use of the relay lens 184 may overcome a potential difficulty in achieving a small distance between the intermediate image plane 181A and the active area of the optical sensor 124. For example, it may be desirable to place an image plane at a distance on the order of 0.1 mm from the optical sensor 124 to obtain a desired blur amount. However, when the optical sensor 124 is an image sensor, typically a protective glass is provided in front of the active area that would prevent placing the image plane at that position. The relay lens 184 may allow the optical sensor 124 to be arbitrarily far from the intermediate image plane 181A while allowing for a conjugate image plane 181B and so may provide freedom to control the amount of blur to a desired value.

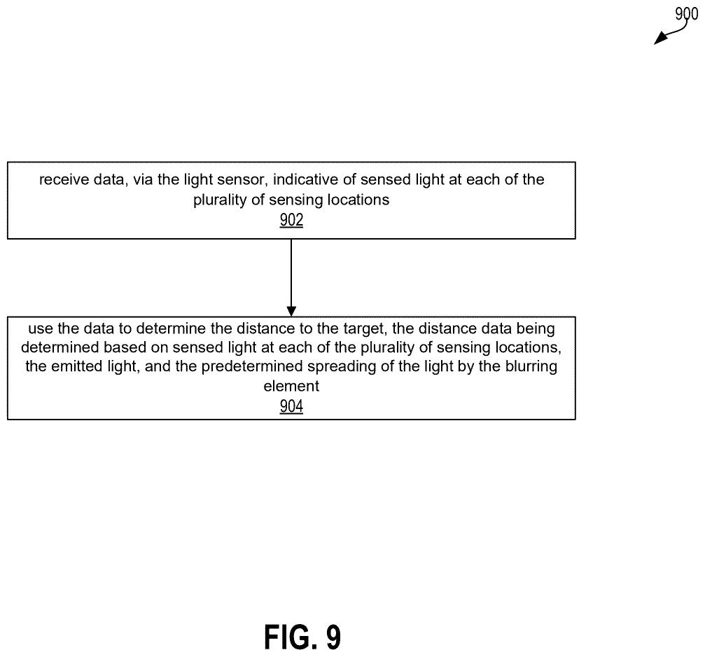

FIG. 9 is a flow chart of a computer-implemented method 900 for determining distance to a target, in accordance with an embodiment.

Step 902 of the method 900 may include receiving data, via the optical sensor, indicative of sensed light at each of the plurality of sensing locations.

Step 904 of the method 900 may include using the data to determine distance data indicative of the distance to the target, the distance data being determined based on sensed light at each of the plurality of sensing locations, the emitted light, and the predetermined spreading of the light by the blurring element.

For example, the data may be generated by an image sensor comprising an array of light sensing pixels.

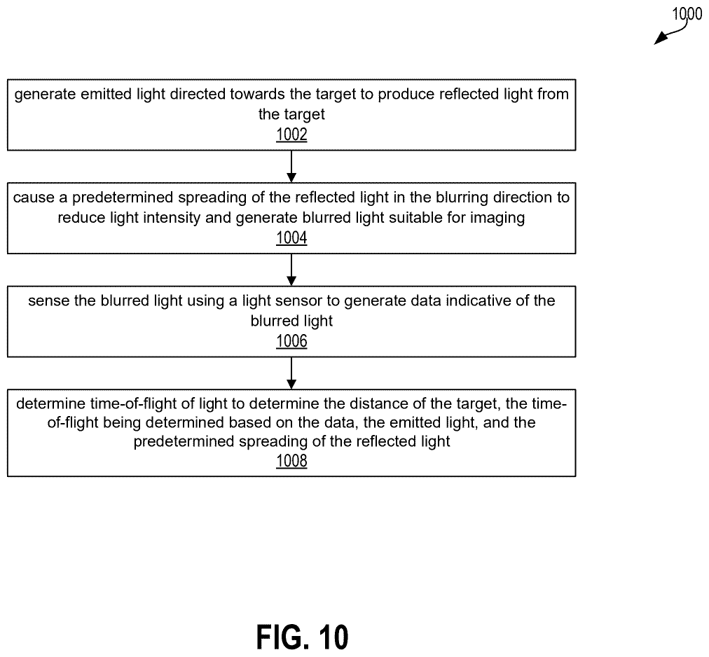

FIG. 10 is a flow chart of a method 1000 of determining distance to a target, in accordance with an embodiment.

Step 1002 of the method 1000 includes generating emitted light directed towards the target to produce reflected light from the target.

Step 1004 of the method 1000 includes causing a predetermined spreading of the reflected light parallel to a blurring axis to reduce light intensity and generate blurred light suitable for imaging. For example, a blurring element may blur light for transmission to (and to be received by) an image-forming objective, which in turn may generate blurred light suitable for imaging.

Step 1006 of the method 1000 includes sensing the blurred light using an optical sensor to generate data indicative of the blurred light.

Step 1008 of the method 1000 includes determining time-of-flight of light to determine the distance of the target, the time-of-flight being determined based on the data, the emitted light, and the predetermined spreading of the reflected light.

In some embodiments of the method 1000, the emitted light is a line of emitted light non-parallel to the blurring axis directed towards the target to produce the reflected light from the target.

In some embodiments of the method 1000, the reflected light is sensed by the optical sensor to define an imaged line associated with reflection of the line of emitted light to facilitate line scanning of the target.

In some embodiments of the method 1000, determining time-of-flight of light based on the data, the emitted light, and the predetermined spreading of the reflected light to determine the distance of the target includes determining a one-dimensional distance array associated with the imaged line.

For example, determining time-of-flight of light based on the data and the predetermined spreading of the reflected light may include summing a plurality of correlations based on a predetermined width of the spreading of the reflected light. For example, only data sensed within the predetermined width may be accumulated to determine a depth. In some embodiments, determining time-of-flight of light based on the data and the predetermined spreading of the reflected light may additionally include, applying a weighting to the summation based on the optical response associated with the predetermined spreading of the reflected light.

In some embodiments of the method 1000, the blurring axis is lateral to the line of emitted light.

In some embodiments of the method 1000, the emitted light is generated from a light emitter that is laterally offset from the optical sensor relative to the target.

In some embodiments of the method 1000, the emitted light is a modulated optical wave.

In some embodiments of the method 1000, determining time-of-flight of light based on the data, the emitted light, and the predetermined spreading of the reflected light to determine the distance of the target comprises using the data to determine a plurality of candidate distances to the target based on phase delay, relative to the emitted light, of the blurred light.

In some embodiments of the method 1000, determining time-of-flight of light based on the data, the emitted light, and the predetermined spreading of the reflected light to determine the distance of the target comprises using the data to estimate a parallax of the imaged line based on an offset between the light emitter and the optical sensor.

In some embodiments of the method 1000, determining time-of-flight of light based on the data, the emitted light, and the predetermined spreading of the reflected light to determine the distance of the target comprises determining the distance to the target using the plurality of candidate distances and the parallax of the imaged line.

In some embodiments of the method 1000, generating emitted light directed towards the target to produce reflected light from the target comprises emitting a sequence of spaced apart lines of light non-parallel to the blurring axis to generate reflected light sensed by the optical sensor to define a corresponding sequence of imaged lines to facilitate line scanning of the target.

In some embodiments of the method 1000, determining time-of-flight of light based on the data, the emitted light, and the predetermined spreading of the reflected light to determine the distance of the target comprises determining a depth map based on a sequence of one-dimensional distance arrays determined based on the corresponding sequence of imaged lines.

In some embodiments of the method 1000, generating emitted light directed towards the target to produce reflected light from the target comprises generating a plurality of mutually incoherent laser beams that are positioned relative to each other to generate a line of light.

In some embodiments of the method 1000, the predetermined spreading of the reflected light in the blurring direction comprises causing non-uniform spreading of light parallel to the blurring axis to non-uniformly reduce light intensity parallel to the blurring axis.

In some embodiments of the method 1000, determining time-of-flight of light based on the data, the emitted light, and the predetermined spreading of the reflected light to determine the distance of the target to determine the distance of the target comprises determining the distance of the target based on averaging in the blurring direction.

In some embodiments of the method 1000, determining time-of-flight of light based on the data, the emitted light, and the predetermined spreading of the reflected light to determine the distance of the target comprises determining the distance of the target based on a plurality of accumulated correlations.

In some embodiments of the method 1000, each of the plurality of accumulated correlations may be associated with a corresponding phase shift. In some embodiments of the method 1000, each of the plurality of accumulated correlations may be determined based on a corresponding plurality of correlations associated with the corresponding phase shift between the emitted light and the sensed light.

In some embodiments of the method 1000, each of the plurality of accumulated correlation signals is a weighted average of the corresponding plurality of correlations. In some embodiments of the method 1000, the weighted average is based on weights at least partially determined by the predetermined spreading of the reflected light.

In some embodiments of the method 1000, the averaging parallel to the blurring axis is a weighted averaging based on inverse-variance weighting.

In some embodiments of the method 1000, determining time-of-flight of light based on the data, the emitted light, and the predetermined spreading of the reflected light to determine the distance of the target comprises determining the distance of the target based on a plurality of accumulated correlations.

In some embodiments of the method 1000, each of the plurality of accumulated correlations is associated with a corresponding phase shift. In some embodiments of the method 1000, each of the plurality of accumulated correlations is determined based on a corresponding plurality of correlations associated with the corresponding phase shift between the emitted light and the blurred light. In some embodiments of the method 1000, each of the plurality of accumulated correlations is determined based on the weighted averaging of a corresponding plurality of correlations associated with the corresponding phase shift between the emitted light and the sensed light.

In some embodiments of the method 1000, determining time-of-flight of light based on the data, the emitted light, and the predetermined spreading of the reflected light to determine the distance of the target comprises using indirect time-of-flight to determine the distance of the target.

FIG. 11 illustrates a block diagram of a computing device 600, in accordance with an embodiment of the present application.

As an example, the method 900, and/or the method 1000, the interface 190, and/or one or more servers may be implemented using the computing device 600 shown in FIG. 11.

The computing device 600 may include at least one processor 602, memory 604, at least one I/O interface 606, and at least one network communication interface 608.

The processor 602 may be a microprocessor or microcontroller, a digital signal processing (DSP) processor, an integrated circuit, a field programmable gate array (FPGA), a reconfigurable processor, or combinations thereof.

The memory 604 may include a computer memory that is located either internally or externally such as, for example, random-access memory (RAM), read-only memory (ROM), compact disc read-only memory (CDROM), electro-optical memory, magneto-optical memory, a programmable read-only memory (PROM), erasable programmable read-only memory (EPROM), electrically-erasable programmable read-only memory (EEPROM), Ferroelectric RAM (FRAM), solid state drive (SSD), magnetic memory (such as a hard disk drive), flash memory, and/or any combination thereof.

The I/O interface 606 may enable the computing device 600 to interconnect with one or more input devices, such as a keyboard, mouse, camera, touch screen and a microphone, or with one or more output devices such as a display screen and a speaker.

In some embodiments, the I/O interface 606 may include a trigger. For example, operation of such a trigger by a user may generate a signal. The signal may be used to determine when to start an exposure or other camera function. For example, operation of a trigger may generate a signal that is then used to indicate the timing of an exposure for co-ordination with other devices in a system.

In some embodiments, the I/O interface 606 may include an encoder input to read the position of a moving stage or conveyor belt. The encoder may indicate the absolute position, or a relative position, which may be an incremental amount of motion (such as provided by a quadrature encoder), which may then be used by the ToF camera system to time exposures to achieve a desired sampling resolution in a direction perpendicular to the line axis 104, e.g. in a line scanning or sequencing application.

The networking interface 608 may be configured to receive and transmit data sets representative of the machine learning models, for example, to a target data storage or data structures. The target data storage or data structure may, in some embodiments, reside on a computing device or system such as a mobile device.

In various embodiments, the networking interface may transmit data acquired by the ToF camera system to another device for further processing or storage. The data may represent points located in 3D space and may include magnitude information related to the amount of light received by the ToF camera system.

As can be understood, the examples described above and illustrated are intended to be exemplary only. For example, the embodiments described in this document provide non-limiting examples of possible implementations of the present technology. Upon review of the present disclosure, a person of ordinary skill in the art will recognize that changes may be made to the embodiments described herein without departing from the scope of the present technology. For example, a direct time-of-flight camera system may implement a blurring element and/or one or more other aspects disclosed herein; one, two, three, four, or more than four phase offsets may be used to determine depth; correlations may be determined indirectly by sensing lighting and then calculating correlated signals; and the parallax may be determined using both position and variation in shape based on the image at the sensor. Yet further modifications could be implemented by a person of ordinary skill in the art in view of the present disclosure, which modifications would be within the scope of the present technology.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

What is claimed is:

1. A time-of-flight camera system to measure distance to a target in a scene, comprising:
a light emitter configured to generate emitted light directed towards the target to produce reflected light from the target, the emitted light being elongated perpendicular to a blurring axis;
an optical sensor defining a plurality of sensing locations to sense the reflected light, the plurality of sensing locations being distributed parallel to the blurring axis;
an image-forming objective optically positioned between the optical sensor and the target; and
a blurring element optically positioned between the optical sensor and the target to blur light that is to be received by the optical sensor via the objective, the blurring element and the image-forming objective together configured to cause a predetermined spreading of light parallel to the blurring axis at the plurality of sensing locations to reduce light intensity at one or more of the plurality of sensing locations, wherein the time-of-flight camera system is operable to determine the distance to the target based on sensed light at each of the plurality of sensing locations, the emitted light, and the predetermined spreading of the light by the blurring element.

2. The time-of-flight camera system of claim 1, wherein the blurring element is selected from a group consisting of a lens, a diffractive optical element, and a diffuser.

3. The time-of-flight camera system of claim 1, wherein the blurring element is a cylindrical lens configured to cause spreading of light parallel to the blurring axis while mitigating spreading of light perpendicular to the blurring axis.

4. The time-of-flight camera system of claim 1, wherein the optical sensor comprises a two-dimensional array of pixel sensors.

5. The time-of-flight camera system of claim 1, wherein the blurring element is configured such that the predetermined spreading of light parallel to the blurring axis is unidirectional spreading of light, and the objective is optically positioned between the blurring element and the optical sensor.

6. The time-of-flight camera system of claim 5, further comprising:
a screen defining a slit and optically positioned between the objective and the optical sensor to block light reaching the plurality of sensing locations from the objective, the objective being configured to allow passage of the reflected light through the slit towards the optical sensor.

7. The time-of-flight camera system of claim 6, wherein the objective forms an intermediate image plane between the objective and the optical sensor, the time-of-flight camera system further comprising:
a relay lens optically positioned between the intermediate image plane and the optical sensor.

8. The time-of-flight camera system of claim 1, wherein the light emitter defines an array of laser beam generators that are mutually incoherent and positioned relative to each other to generate a line of light.

9. The time-of-flight camera system of claim 1, wherein the blurring element is configured to cause a non-uniform spreading of the light parallel to the blurring axis to mitigate sensor saturation of the optical sensor by non-uniformly reducing light intensity parallel to the blurring axis.

10. The time-of-flight camera system of claim 1, further comprising:
one or more processors; and
non-transitory, computer-readable memory coupled to the one or more processors and storing processor-executable instructions that, when executed, configure the one or more processors to:
receive data, via the optical sensor, indicative of the sensed light at each of the plurality of sensing locations, and
use the data to determine distance data indicative of the distance to the target, the distance data being determined based on the sensed light at each of the plurality of sensing locations, the emitted light, and the predetermined spreading of the light by the blurring element.

11. The time-of-flight camera system of claim 10, wherein the one or more processors is configured to use the data to determine the distance data indicative of the distance to the target based on a plurality of accumulated correlations, each of the plurality of accumulated correlations being associated with a corresponding phase shift and being determined based on a corresponding plurality of correlations associated with the corresponding phase shift between the emitted light and the sensed light.

12. The time-of-flight camera system of claim 11, wherein said each of the plurality of accumulated correlations is a weighted average of the corresponding plurality of correlations, the weighted average being based on weights at least partially determined by the predetermined spreading of light by the blurring element.

13. The time-of-flight camera system of claim 12, wherein said each of the plurality of accumulated correlations is a weighted average of the corresponding plurality of correlations, the weighted average being based on data indicative of a plurality of electron counts, each of the plurality of electron counts being associated with a corresponding one of the plurality of correlations.

14. The time-of-flight camera system of claim 10, wherein the light emitter, the optical sensor, the objective, the blurring element, the one or more processors, and the non-transitory, computer-readable memory form an integrated camera assembly.

15. The time-of-flight camera system of claim 10, wherein the predetermined spreading of light parallel to the blurring axis is unidirectional spreading of light, the light emitter is configured to emit a sequence of lines of light non-parallel to the blurring axis to generate reflected light sensed by the optical sensor via the blurring element to define a corresponding sequence of imaged lines to facilitate line scanning of the target, and the one or more processors are configured to use the data to determine a depth map based on a sequence of one-dimensional distance arrays determined based on the corresponding sequence of imaged lines.

16. The time-of-flight camera system of claim 10, wherein the predetermined spreading of light parallel to the blurring axis is unidirectional spreading of light, the emitted light is a line of emitted light non-parallel to the blurring axis, the reflected light is at least partially sensed by the optical sensor via the blurring element to define an imaged line associated with reflection of the line of emitted light to facilitate line scanning of the target, and the one or more processors is configured to use the data to determine a one-dimensional distance array associated with the imaged line and indicative of corresponding distances of one or more objects in the scene.

17. The time-of-flight camera system of claim 16, wherein the light emitter and the optical sensor are laterally offset from each other relative to the target, the emitted light is a modulated optical wave, and the one or more processors is configured to
use the data to determine a plurality of candidate distances to the target based on phase delay, relative to the emitted light, of the reflected light,
estimate a parallax of the imaged line based on the data and an offset between the light emitter and the optical sensor, and
determine the distance to the target using the plurality of candidate distances and the parallax of the imaged line.

18. A method of determining distance to a target, comprising:
generating emitted light directed towards the target to produce reflected light from the target;
causing a predetermined spreading of the reflected light parallel to a blurring axis to reduce light intensity and generate blurred light suitable for imaging;
sensing the blurred light using an optical sensor to generate data indicative of the blurred light; and
determining time-of-flight of light to determine the distance of the target, the time-of-flight being determined based on the data, the emitted light, and the predetermined spreading of the reflected light.

19. The method of claim 18, wherein generating the emitted light directed towards the target to produce reflected light from the target comprises
generating a line of emitted light non-parallel to the blurring axis directed towards the target to produce the reflected light from the target, the reflected light being sensed by the optical sensor to define an imaged line associated with reflection of the line of emitted light to facilitate line scanning of the target, and
determining the time-of-flight of light based on the data, the emitted light, and the predetermined spreading of the reflected light to determine the distance of the target comprises
determining a one-dimensional distance array associated with the imaged line.

20. The method of claim 19, wherein determining the time-of-flight of light based on the data, the emitted light, and the predetermined spreading of the reflected light to determine the distance of the target comprises
determining the distance of the target based on a plurality of accumulated correlations, each of the plurality of accumulated correlations being associated with a corresponding phase shift and being determined based on a weighted average of a corresponding plurality of correlations associated with the corresponding phase shift between the emitted light and the blurred light.

21. The method of claim 19, wherein generating the emitted light directed towards the target to produce the reflected light from the target comprises generating the emitted light from a light emitter that is laterally offset from the optical sensor relative to the target, such that the emitted light is a modulated optical wave forming a line of emitted light, and wherein determining the time-of-flight of light based on the data, the emitted light, and the predetermined spreading of the reflected light to determine the distance of the target comprises
using the data to determine a plurality of candidate distances to the target based on phase delay, relative to the emitted light, of the blurred light,
using the data to estimate a parallax of the imaged line based on an offset between the light emitter and the optical sensor, and
determining the distance to the target using the plurality of candidate distances and the parallax of the imaged line.

22. The method of claim 18, wherein generating the emitted light directed towards the target to produce the reflected light from the target comprises
generating a plurality of mutually incoherent laser beams that are positioned relative to each other to generate a line of emitted light.

23. The method of claim 18, wherein causing the predetermined spreading of the reflected light parallel to the blurring axis to reduce light intensity and generate blurred light comprises
causing non-uniform spreading of light parallel to the blurring axis to non-uniformly reduce light intensity parallel to the blurring axis.

24. The method of claim 18, wherein determining the time-of-flight of light based on the data, the emitted light, and the predetermined spreading of the reflected light to determine the distance of the target comprises
determining the distance of the target based on a plurality of accumulated correlations, each of the plurality of accumulated correlations being associated with a corresponding phase shift and being determined based on a corresponding plurality of correlations associated with the corresponding phase shift between the emitted light and the blurred light.

25. The method of claim 24, wherein determining the distance of the target based on a plurality of accumulated correlations, each of the plurality of accumulated correlations being associated with a corresponding phase shift and being determined based on a corresponding plurality of correlations associated with the corresponding phase shift between the emitted light and the blurred light, comprises
determining the distance based on each of the plurality of accumulated correlations being a weighted average of the corresponding plurality of correlations, the weighted average being based on weights at least partially determined by the predetermined spreading of the reflected light.

26. The method of claim 18, wherein causing the predetermined spreading of the reflected light parallel to the blurring axis to reduce light intensity and generate blurred light comprises
using a blurring element to spread the reflected light, the blurring element being selected from a group consisting of a lens, a diffractive optical element, and a diffuser.
